(19) United States
(12) Patent Application Publication
(10) Pub. No.: US 2004/0132437 A1
(43) Pub. Date: Jul. 8, 2004

(54) Information distribution system and memory card

(76) Inventors: Motoji Ohmori, Hirakata (JP); Natsume Matsuzaki, Mino (JP); Yoshiaki Nakanishi, Suginami-ku (JP); Atsushi Saso, Kawasaki (JP)

Correspondence Address: WENDEROTH, LIND & PONACK, L.L.P., 2033 K STREET N. W., SUITE 800, WASHINGTON, DC, 20006-1021, US

(21) Appl. No.: 10/690,547

(22) Filed: Oct. 23, 2003

(30) Foreign Application Priority Data
Oct. 24, 2002 (JP) 2002-310128

(51) Int. Cl. H04Q 7/20

(52) U.S. Cl. 455/414.1; 455/414.3; 455/425; 455/550.1

(57) ABSTRACT

An information distribution system is composed of: an information distribution device that transmits advertisement information issued by an information provider; a communication terminal that receives the advertisement information and sends the received advertisement information to a memory card; the memory card that is portable and mountable on the communication terminal. The memory card is provided to the user at a cost borne by the information provider at least partly, and includes a storage unit having an area for storing advertisement information, a judging unit for judging whether the received advertisement in formation is issued by the information provider, and a writing unit for writing the received advertisement information if judged to be issued by the information provider. The information distribution system enables a memory card provider to provide a memory card to a user at no or lower cost than would otherwise be fully payable by the user.

This application is based on an application No. 2002-310128 filed in Japan, the content of which is hereby incorporated by reference.

### BACKGROUND OF THE INVENTION

(1.) Field of the Invention

The present invention relates to an information distribution system for an information provider to distribute information to users.

(2.) Description of the Related Art

Recently, an increasing number of mobile phones are capable of local communication with an external source through the use of short-range radio communication such as infrared and BlueTooth. Further, short-range radio network services are available at various locations including restaurants, airports, stations, and hotels, so that Internet access is offered at those locations.

In addition, an increasing number of mobile phones are connectible to a memory card as a means for storing image data and audio data. JP unexamined patent application publication No. 06-315109 discloses a technique for storing image data taken by an image-taking device such as a digital camera into a memory card in association with text data.

Unfortunately, however, there is a problem that memory cards are relatively expensive, so that a solution is required for the widespread use of memory cards.

### SUMMARY OF THE INVENTION

In order to meet the problem, the present invention has an object to provide an information distribution system, an information distribution device, and an inexpensive memory card each allow for wider use of memory cards.

To achieve the object stated above, the present invention provides an information distribution system composed of a sponsor server, a server, a short-range radio communication device, a mobile phone, a sponsor card, and a register. The sponsor server stores advertisement information and coupon information of a sponsor baring the cost of a memory card at least partly, and transmits the stored advertisement information and coupon information to the server. The server stores the advertisement information and coupon information transmitted from the sponsor server, and transmits the stored advertisement information and coupon information to the short-range radio communication device. The short-range radio communication device stores the advertisement information and coupon information transmitted from the server, and repeatedly transmits the stored advertisement information and coupon information over a predetermined range. The mobile phone receives the advertisement information and coupon information transmitted from the short-range radio communication device. The sponsor card is the memory card that is provided to a user at the cost borne at least partly by the sponsor. The sponsor card acquires the advertisement information and coupon information from the mobile phone, and verifies whether the acquired information is issued by the sponsor of the sponsor card. On verifying that the information is issued by the sponsor, the sponsor card stores the received information. The register receives the coupon information that the mobile phone reads from the sponsor card and transmits to the register, verifies whether the received coupon information is issued by the sponsor of the register. On judging that the received coupon information is issued by the sponsor of the register, the register provides to the user a service shown by the coupon information.

With the above system, advertisement information and coupon information are transmitted to a number of uses, which achieves an advertising effect. In addition, since the sponsor bears the cost of sponsor cards at least partly, the users are provided with a sponsor card at no or lower cost than would otherwise be fully payable by the user.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a block diagram showing a system employing a sponsor card 200;

FIG. 2 is a block diagram showing the structure of a sponsor server 510;

FIG. 3 is a block diagram showing the structure of a server 400;

FIG. 4 is a block diagram showing the structure of a short-range radio communication device 310;

FIG. 5 is a block diagram showing the structure of a mobile phone 100;

FIG. 6 is a block diagram showing the structure of a sponsor card 200;

FIG. 7 is a block diagram showing the structure of a register 601;

FIG. 8 is a flowchart showing operations performed for transmitting advertisement information and coupon information from the sponsor server 510 to the short-range radio communication device 310 (to be continued to FIG. 9);

FIG. 9 is a flowchart showing operations performed for transmitting advertisement information and coupon information from the short-range radio communication device 310 to the sponsor card 200 (continued from FIG. 8 and to be continued to FIG. 10);

FIG. 10 is a flowchart showing operations performed by the short-range radio communication device 310 for vilification of digital signature data (continued from FIG. 9 and to be continued to FIG. 11);

FIG. 11 is a flowchart showing operations performed for writing coupon information (continued from FIG. 10);

FIG. 12 is a flowchart showing operations performed when a user uses coupon information (to be continued to FIG. 13);

FIG. 13 is a flowchart showing operations performed when a user uses coupon information (continued from FIG. 12);

FIG. 14 is a flowchart showing operations for transmitting a write count from the sponsor card 200 to the server 400;

FIG. 15 is a flowchart showing operations performed for transmitting a use count from the register 601 to the sponsor server 510;

FIG. 16 is a block diagram showing the structure of a system which allows a user to reject PUSH information;

FIG. 17 is a view showing the structure of a PUSH information list stored in a server 400b;

FIGS. 18A, 18B, and 18C are views showing the structures of category tables showing categories of PUSH information;

FIG. 19 is a view showing the structure of information that is stored by a server 400b in a user area; and

FIG. 20 is a flowchart showing operations performed by a sponsor card 200b to store PUSH information.

### DESCRIPTION OF THE PREFERRED EMBODIMENT

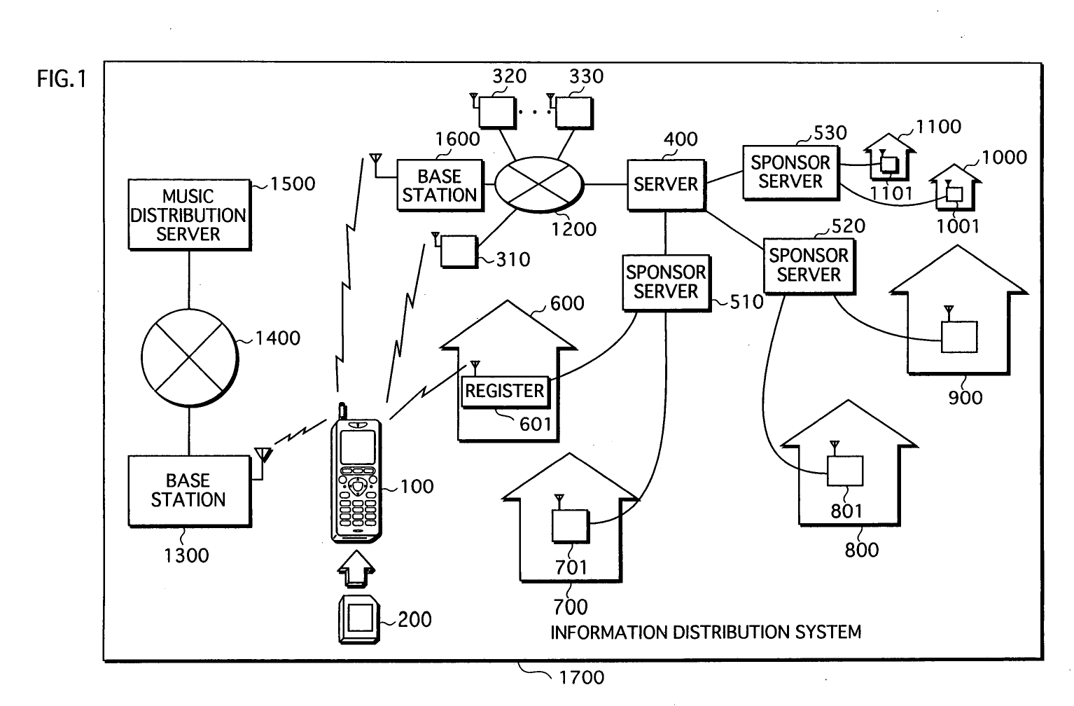

As shown in FIG. 1, an information distribution system 1700 is composed of: a mobile phone 100; a sponsor card 200; short-range radio communication devices 310, 320, and 330; a server 400; sponsor servers 510, 520, and 530; registers 601, 701, 801, 901, 1001, and 1101; a communication network 1200; a base station 1300; a communication network 14.00; a music distribution server 1500; and a base station 1600.

The sponsor server 510 transmits advertisement information, coupon information, and digital signature data all of a sponsor A, to the mobile phone 100 via the server 400, the communication network 1200, and the short-range radio communication device 310.

The mobile phone 100 receives advertisement information, coupon information, and digital signature data, writes the received coupon information to the sponsor card 200, and displays the received advertisement information.

Further, the mobile phone 100 transmits coupon information to the register 601. On receiving coupon information, the register 601 operates so as to provide a service shown by the received coupon information.

Hereinafter, description is given in detail to each component of the information distribution system 1700.

1.1 Sponsor Servers 510, 520, and 530

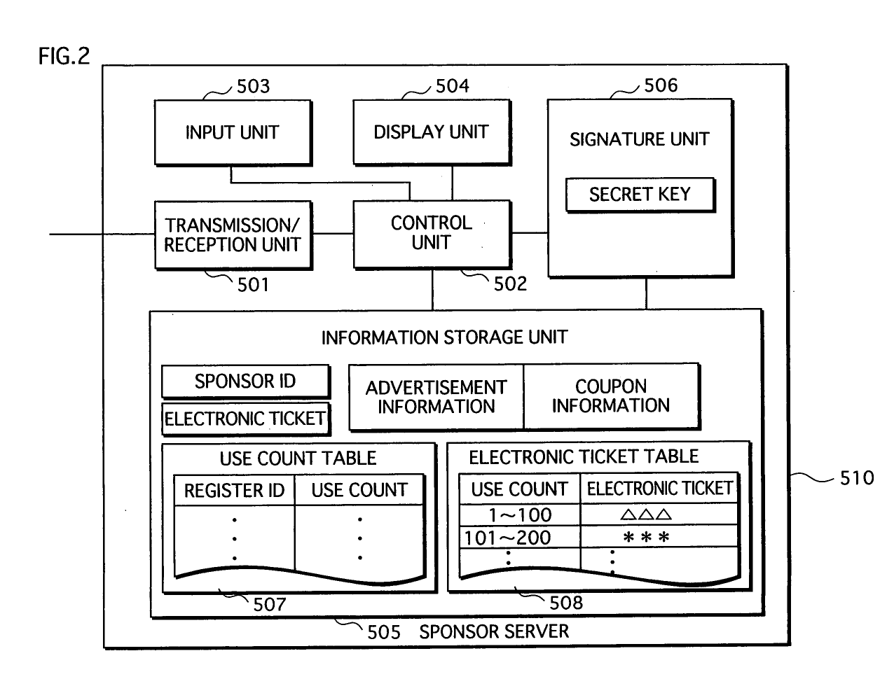

The sponsor server 510 stores and transmits advertisement information and coupon information of the sponsor A. As shown in FIG. 2, the sponsor server 510 is composed of a transmission/reception unit 501, a control unit 502, an input unit 503, a display unit 504, an information storage unit 505, and a signature unit 506.

The sponsor servers 520 and 530 for information of sponsors B and C, respectively, are similar in structure to the sponsor server 510. Thus, description thereof is omitted.

Physically, the sponsor server 510 is a computer system that is composed generally of a microprocessor, a ROM, a RAM, a hard disk unit, a display unit, a keyboard, and a mouse.

The RAM or the hard disk unit stores a computer program. The sponsor server 510 performs its function by the microprocessor operating according to the computer program.

Hereinafter, description is given in detail to each component of the sponsor server 510.

(1) Information Storage Unit 505

The information storage unit 505 stores a sponsor ID identifying the sponsor A, advertisement information, one or more pieces of coupon information, and an electronic ticket, which serves as money. The advertisement information shows an advertisement for a shop that is directly managed by, or that has a tie-up with the sponsor A. Each piece of coupon information shows a service, such as a discount service, available at a shop that is directly managed by, or that has a tie-up with the sponsor A. Each piece of coupon information includes a coupon ID that identifies the coupon information.

The information storage unit 505 additionally stores a use count table 507 and an electronic ticket table 508. The use count table 507 contains register IDs each identifying a register and associated with a use count that represents how many times coupon information has been used through the register. The electronic ticket table 508 contains use counts each associated with a corresponding amount of monetary value that is to be paid as a commission by an electronic ticket.

(2) Input Unit 503

The input unit 503 receives input from an external source. On receiving input of a coupon ID, the input unit 503 sends the received coupon ID to the control unit 502.

(3) Signature Unit 506

The signature unit 506 stores a secret key of the sponsor A. On receiving a coupon ID from the control unit 502, the signature unit 506 reads from the information storage unit 505, coupon information having a coupon ID that matches the received coupon ID. The signature unit 506 then applies a digital signature algorithm S to the read coupon information to generate digital signature data.

The digital signature algorithm S used herein is, for example, the ElGamal signature algorithm, which is based on the discrete logarithm problem in finite fields. Since the ElGamal signature algorithm it is well known in the art, description thereof is omitted.

The signature unit 506 then outputs the generated digital signature data to the control unit 502.

(4) Control Unit 502

On receiving a coupon ID from the input unit 503, the control unit 502 sends the received coupon ID to the signature unit 506.

Further, on receiving digital signature data from the signature unit 506, the control unit 502 reads from the information storage unit 505, the sponsor ID, coupon information having a coupon ID that matches the received coupon ID and the advertisement information. The control unit 502 then transmits the digital signature data, the sponsor ID, the advertisement information, and the coupon information to the server 400 via the transmission/reception unit 501.

On receiving a register ID and a use count from the register 601 or 701 via the transmission/reception unit 501, the control unit 502 writes the received register ID in association with the received use count into the use count table 507. The control unit 502 then reads from the electronic ticket table 508, an amount of monetary value that corresponds to the received use count, and transmits an electronic ticket having the read monetary value to the register that is identified by the received register ID.

(5) Display Unit 504

The display unit 504 displays information under instructions from the control unit 502.

1.2 Server 400

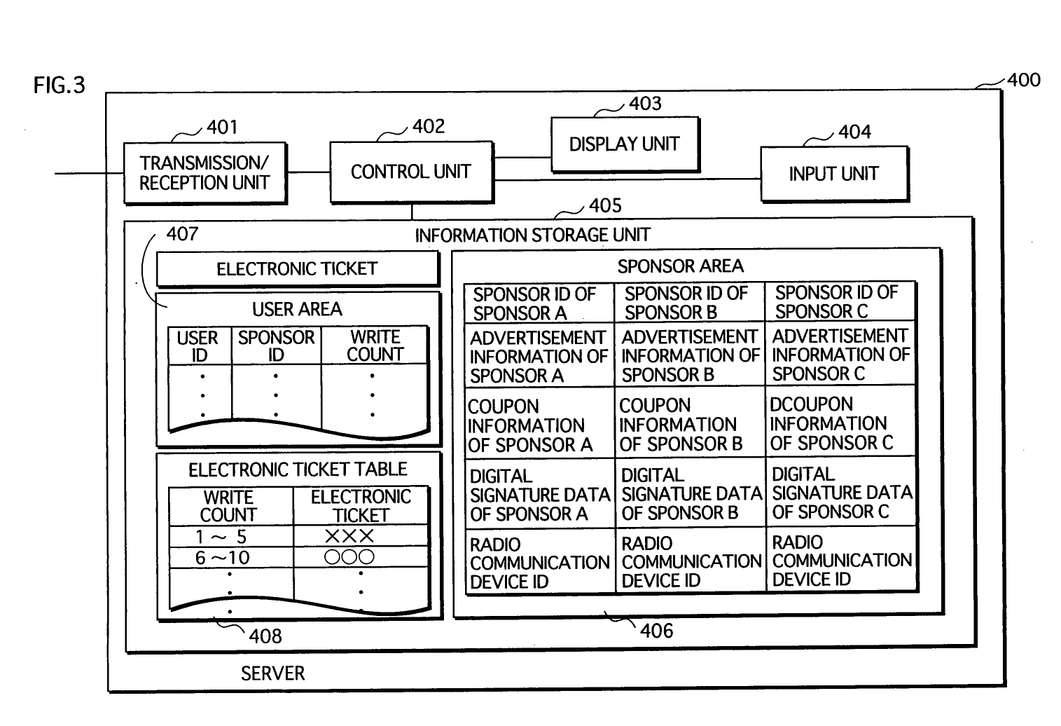

As shown in FIG. 3, the server 400 is composed of a transmission/reception unit 401 for information transmission, a control unit 402, a display unit 403 for displaying information under instructions from the control unit 402, an input unit 404 for receiving input from an external source, and an information storage unit 405.

Physically, the server 400 is a computer system that is composed generally of a microprocessor, a ROM, a RAM, a hard disk unit, a display unit, a keyboard, and a mouse.

The RAM or the hard disk unit stores a computer program. The server 400 performs its function by the microprocessor operating according to the computer program.

Hereinafter, description is given in detail to each component of the server 400.

(1) Information Storage Unit 405

The information storage unit 405 has a sponsor area 406, a user area 407, and an electronic ticket table 408. In addition, the information storage unit 405 stores an electronic ticket.

The sponsor area 406 is an area that includes sub-areas for separately storing information received from the sponsor servers 510-530. Each sub-area is identified by a sponsor ID, and stores advertisement information, coupon information, and digital signature data of a corresponding sponsor as well as a communication device ID of a short-range radio communication device that belongs to the corresponding sponsor.

The user area 407 is an area for storing a user ID, a sponsor ID, and a write count in association with one another. The user ID identifies a user of the sponsor card 200, and is a telephone number of the mobile phone 100, which is owned by that user. The write count is a number of times coupon information of a corresponding sponsor is written to the sponsor card 200. The user ID, sponsor ID, and write count are received from the mobile phone 100.

The electronic ticket table 408 contains write counts each associated with a corresponding amount of monetary value to be paid to the user by an electronic ticket. The user may use an electronic ticket in payment of fees for exchanging the sponsor card 200 with another sponsor card having a larger capacity, or acquiring a new card in addition to the sponsor card 200.

(2) Control Unit 402

The control unit 402 receives a sponsor ID, advertisement information, coupon information, and digital signature data from the sponsor server 510 via the transmission/reception unit 401. Upon receipt, the control unit 402 writes the received information into a sub-area of the sponsor area 406 that is identified by the received sponsor ID. The control unit 402 performs similar processing when receiving similar information from the sponsor servers 520 and 530.

The control unit 402 daily reads from each sub-area of the information storage unit 405, a sponsor ID, advertisement information, coupon information, digital signature data, and a communication device ID, and sequentially transmits, via the transmission/reception unit 401, the read sponsor ID, advertisement information, coupon information, and digital signature data to a short-range radio communication device ID identified by the read communication device ID.

Further, the control unit 402 receives a write count and a user ID from the mobile phone 100 via the base station 1600, the communication network 1200, and the transmission/reception unit 401. Upon receipt, the control unit 402 writes the received write count and user ID into the user area. At a later time, the control unit 402 reads a user ID and a write count from the user area 407, and reads from the electronic ticket table 408, an amount of monetary value corresponding to the read write count. The control unit 402 then transmits an electronic ticket having the read monetary value to the mobile phone identified by the read user ID. Subsequently, the control unit 402 subtracts the transmitted amount of monetary value from the electronic ticket stored in the information storage unit 405.

1.3 Short-Range Radio Communication Device 310, 320, and 330

The short-range radio communication device 310 belongs to the sponsor A.

The short-range radio communication device 310 is a Bluetooth compliance communication device with the transmission range of 10 m, frequency range of 2.4 GHz, and data transmission rate of about 1 Mbps. The short-range radio communication device 310 performs mutual authentication prior to every communication with another device, and repeatedly transmits advertisement information and coupon information of the sponsor A.

Note that the short-range radio communication device is not necessarily in compliance with Bluetooth standard as long as the device is capable of short range communication in a secure manner. Further, although authentication is performed under the Bluetooth standard, description thereof is omitted as it is not directly relevant to the gist of the present invention.

The other short-range radio communication devices 320 and 330 are similar to the short-range radio communication device 310, and belong to one of the sponsors A, B, and C.

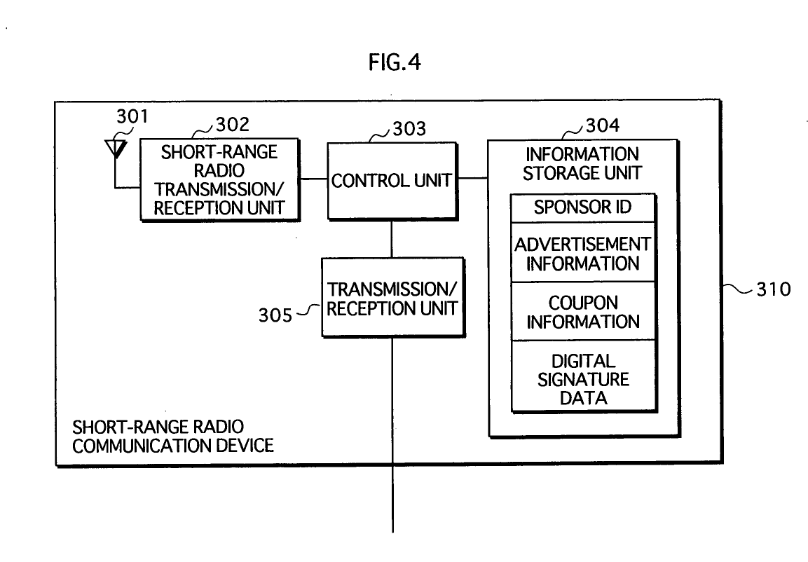

As shown in FIG. 4, the short-range radio communication device 310 is composed of a short-range radio antenna 301, a short-range radio transmission/reception unit 302, a control unit 303, an information storage unit 304, and a transmission/reception unit 305.

The short-range radio communication devices 320 and 330 are similar in structure to the short-range radio communication device 310, and thus description thereof is omitted.

(1) Information Storage Unit 304

The information storage unit 304 has a sponsor area storing a sponsor ID, advertisement information, coupon information, digital signature data, all of which are of the sponsor A.

(2) Control Unit 303

The control unit 303 receives the sponsor A's sponsor ID, advertisement information, coupon information, and digital signature data from the server 400 via the transmission/reception unit 305. Upon receipt, the control unit 303 writes the received information into the information storage unit 304.

The control unit 303 reads the sponsor ID, advertisement information, coupon information, and digital signature data from the information storage unit 304, and repeatedly transmits the read sponsor ID, advertisement information, coupon information, and digital signature data from the short-range radio transmission/reception unit 302 via the short-range radio antenna 301.

1.4 Mobile Phone 100

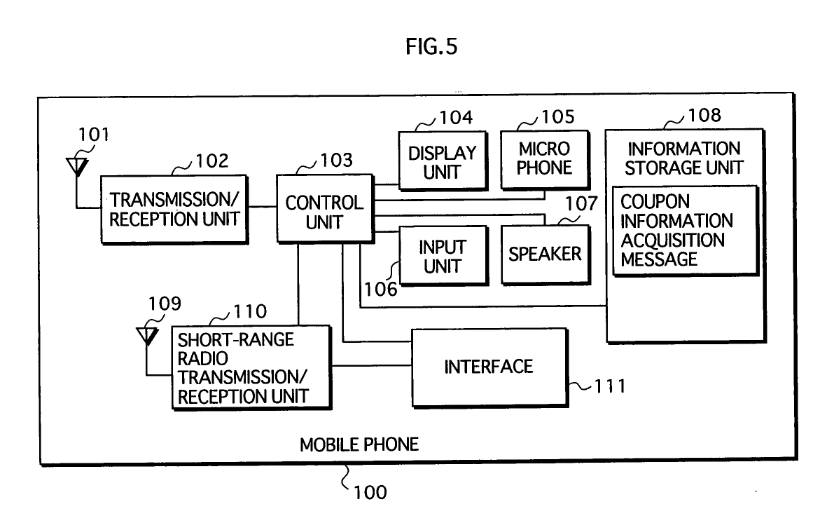

As shown in FIG. 5, the mobile phone 100 owned by the user is composed of an antenna 101, a transmission/reception unit 102, a control unit 103, a display unit 104, a microphone 105, an input unit 106, a speaker 107, an information storage unit 108, a short-range radio antenna 109, a short-range radio transmission/reception unit 110, and an interface 111. The sponsor card 200 is connected to the interface 111.

Hereinafter, description is given in detail to each component of the mobile phone 100.

(1) Information Storage Unit 108

The information storage unit 108 stores a message for informing the user that coupon information is received from the short-range radio communication device 310.

(2) Control Unit 103

The control unit 103 receives: music information from the music distribution server 1500; a sponsor ID, advertisement information, coupon information, and digital signature data from the short-range radio communication device 310; advertisement information, a write count, a user ID, a sponsor ID, and coupon information from the sponsor card 200; and a coupon ID from the input unit 106.

On receiving music information from the music distribution server 1500 via the transmission/reception unit 102, the antenna 101, the base station 1300, and the communication network 1400, the control unit 103 sends the received music information to the sponsor card 200 via the interface 111.

On receiving a sponsor ID, advertisement information, coupon information, and digital signature data from the short-range radio communication device 310 via the short-range radio antenna 109 and the short-range radio transmission/reception unit 110, the control unit 103 sends the received sponsor ID, advertisement information, coupon information, and digital signature data to the sponsor card 200 via the interface 111.

On receiving advertisement information from the sponsor card 200 via the interface 111, the control unit 103 reads the coupon information acquisition message from the information storage unit 108, and controls the display unit 104 so as to display the read message and the received advertisement information. On receiving a write count and a user ID, the control unit 103 transmits the received write count and user ID to the server 400 via the transmission/reception unit 102 and the antenna 101.

On receiving a coupon ID inputted via the input unit 106, the control unit 103 outputs to the sponsor card 200 via the interface 111, an instruction to read coupon information having a coupon ID matching the received coupon ID and a sponsor ID identifying the sponsor that issued the coupon information.

On receiving the sponsor ID of the sponsor A and coupon information from the sponsor card 200, the control unit 103 transmits the received sponsor ID and coupon information to the register 601 via the short-range radio transmission/reception unit 110 and the short-range radio antenna 109.

On receiving an electronic ticket from the server 400 via the antenna 101 and the transmission/reception unit 102, the control unit 103 sends the received electronic ticket to the sponsor card 200 via the interface 111.

(3) Input Unit 106

The input unit 106 receives input from an external source.

On receiving input of a coupon ID, the input unit 106 sends the received coupon ID to the control unit 103.

(4) Display Unit 104

The display unit 104 displays information under instructions from the control unit 103. For example, the display unit 104 receives the coupon information acquisition message from the control unit 103 and displays the received message.

(5) Microphone 105

The microphone 105 receives audio input from an external source.

(6) Speaker 107

The speaker 107 plays back audio data under instructions from the control unit 103.

1.5 Sponsor Card 200

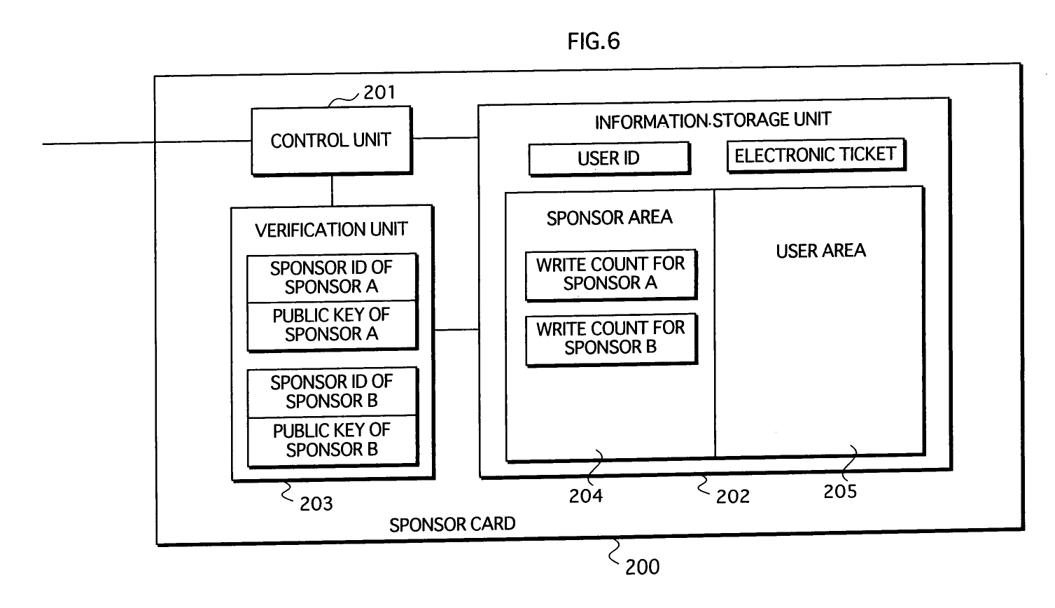

The sponsor card 200 is a portable, semiconductor memory card, and is composed of, as shown in FIG. 6, a control unit 201, an information storage unit 202, and a verification unit 203.

The sponsors A and B each bear at least part of the cost of the sponsor card 200, so that the sponsor card 200 is provided to the user at no or lower cost than would otherwise be fully payable by the user.

Physically, the sponsor card 200 is a computer system composed generally of a microprocessor, a ROM, and a RAM.

The RAM stores a computer program. The sponsor card 200 performs its function by the microprocessor operating according to the computer program.

Hereinafter, description is given in detail to each component of the sponsor card 200.

(1) Information Storage Unit 202

The information storage unit 202 stores a user ID identifying the user who owns the sponsor card 200.

In addition, the information storage unit 202 has an area for storing an electronic ticket, a sponsor area 204 for storing coupon information of the sponsors A and B, and a user area 205 that may store music, images, and video freely used by the user.

The user may remove the sponsor card 200 from the mobile phone 100 and connect the sponsor card 200 to another connectible device in order to use the stored music, images, and video on that device.

Each piece of coupon information includes a coupon ID that identifies the coupon information.

Further, the information storage unit 202 stores, for each sponsor, a write count showing how many times coupon information of a corresponding sponsor has been written into the sponsor area 204.

(2) Verification Unit 203

The verification unit 203 stores a sponsor ID and a public key of the sponsor A as well as a sponsor ID and a public key of the sponsor B. The public key of the sponsor A is generated through a public key generation algorithm using a secret key of the sponsor A. The public key generation algorithm is based on the ElGamal signature algorithm. When the sponsor A pays a part of the cost of the sponsor card 200 to the card provider, the card provider writes the public key of the sponsor A to the sponsor card 200. Similarly, the public key of the sponsor card B is generated by using a secret key of the sponsor B, and is written to the sponsor card 200 in return for payment of a part of the cost of the sponsor card 200.

Note that the cost of the sponsor card may be borne fully by one or more sponsors.

On receiving a sponsor ID, coupon information, digital signature data from the control unit 201, the verification unit 203 retrieves sponsor IDs of the sponsors A and B stored therein, and verifies whether the received sponsor ID matches either of the retrieved sponsor IDs.

On verifying that there is a match, the verification unit 203 retrieves a public key of the sponsor that is identified by the matching sponsor ID. The verification unit 203 then applies a signature verification algorithm V using the retrieved public key to the received digital signature data, and outputs whether the signature verification ends in success or failure.

The signature verification algorithm V is an algorithm for verifying digital signature data that is generated through the digital signature algorithm S.

When the signature verification is successful, the verification unit 203 further verifies whether any of the coupon IDs of the coupon information recorded in the sponsor area 204 matches the received coupon ID.

On verifying that no coupon ID matches the received coupon ID, the verification unit 203 outputs write permission as a verification result. On the other hand, on verifying that 1) the received sponsor ID matches none of the stored sponsor IDs, 2) the signature verification fails, or 3) the coupon information identified by the received coupon ID has been recorded already, the verification unit 203 outputs write inhibition to the control unit 201 as a verification result.

(3) Control Unit 201

The control unit 201 receives music information, a sponsor ID, advertisement information, coupon information, and digital signature data from the mobile phone 100.

On receiving music information, the control unit 201 writes the received music information into the user area 205.

On receiving a sponsor ID, advertisement information, coupon information, and digital signature data, the control unit 201 extracts the sponsor ID, the coupon information, and the digital signature data from all the received information, and sends the extracted information to the verification unit 203.

Further, the control unit 201 receives a verification result from the verification unit 203. On receiving write permission as the verification result, the control unit 203 writes the coupon information into the sponsor area 204, adds “1” to a corresponding write count, and sends the advertisement information to the mobile phone 100. On receiving write inhibition, on the other hand, the verification unit 203 does not write the coupon information.

Further, the control unit 201 monthly reads, for each sponsor, a write count, a user ID, and a sponsor ID from the sponsor area 204, and sends the read information to the mobile phone 100. The control unit 201 then resets each write count stored in the information storage unit 202 to “0”.

Further, the control unit 201 receives from the mobile phone 100, a coupon ID which serves as an instruction to read coupon information identified by that coupon ID and a sponsor ID identifying the sponsor that issued the identified coupon information. In response, the control unit 201 reads the coupon information and the sponsor ID from the sponsor area 204 as instructed, and outputs the read coupon information and sponsor ID to the mobile phone 100.

On receiving an electronic ticket, the control unit 201 writes the received electronic ticket to the information storage unit 202.

1.6 Registers 601 and 701

The registers 601 and 701 are located at shops 600 and 700, respectively. The shops 600 and 700 are directly managed by, or have a tie-up with the sponsor A. Similarly, the registers 801-1101 are located at shops 800-1100 that are directly managed by, or that have a tie-up with the sponsor B or C.

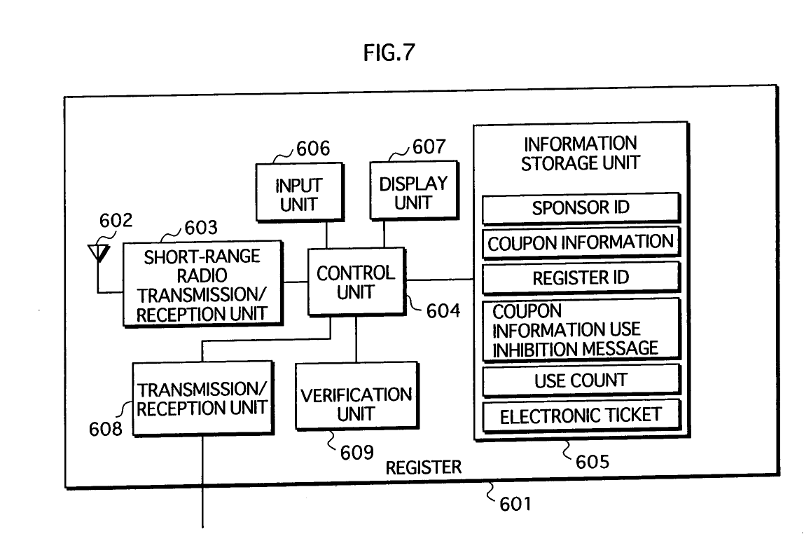

As shown in FIG. 7, the register 601 is composed of a short-range radio antenna 602, a short-range radio transmission/reception unit 603, a control unit 604, an information storage unit 605, an input unit 606, a display unit 607, a transmission/reception unit 608, and a verification unit 609.

Since each of the registers 701-1101 is similar in structure to the register 601, and thus the description thereof is omitted.

Hereinafter, description is given to each component of the register 601.

(1) Information Storage Unit 605

The information storage unit 605 stores a sponsor ID of the sponsor A and a coupon ID of each piece of coupon information issued by the sponsor A. In addition, the information storage unit 605 stores a register ID identifying the register 601.

The information storage unit 605 stores a use count that shows how many times a service represented by coupon information has been provided.

The information storage unit 605 also has an area for storing an electronic ticket.

The information storage unit 605 also stores a message informing a user that a service represented by coupon information is not available because of the verification result by the verification unit 609.

(2) Verification Unit 609

On receiving a coupon ID and a sponsor ID from the control unit 604, the verification unit 609 reads the stored sponsor ID and coupon IDs from the information storage unit 605. The verification unit 609 then verifies whether the received sponsor ID matches the read sponsor ID. On verifying that the two sponsor IDs match, the verification unit 609 then verifies whether the received coupon ID matches any of the read coupon IDs. On verifying that there is a coupon ID matching the received coupon ID, the verification unit 609 outputs, as a verification result, use permission to the control unit 604. On the other hand, on verifying that the received sponsor ID does not match the read sponsor ID or that none of the stored coupon IDs matches the received coupon ID, the verification unit 609 outputs, as a verification result, use inhibition to the control unit 604.

(3) Control Unit 604

The control unit 604 receives a sponsor ID and coupon information along with the coupon ID from the mobile phone 100 via the short-range radio antenna 602 and the short-range radio transmission/reception unit 603, and sends the received sponsor ID and coupon ID to the verification unit 609.

The control unit 604 receives a verification result from the verification unit 203. On receiving use inhibition as the verification result, the control unit 604 reads the message informing a user that the service represented by the coupon information is not available, and controls the display unit 607 so as to display the read message. On the other hand, on receiving use permission as the verification result, the control unit 604 operates so as to provide a service represented by the coupon information, and adds “1” to the use count stored in the information storage unit 605.

The control unit 604 monthly reads from the information storage unit 605, the use count and the register ID that is unique to the register 601, and transmits the read information to the sponsor server 510 via the transmission/reception unit 608.

On receiving an electronic ticket as a commission fee that is determined depending on the use count, the control unit 604 stores the received electronic ticket into the information storage unit 605.

(3) Input Unit 606

The input unit 606 receives input from an external source.

(4) Display Unit 607

The display unit 607 displays information under instructions from the control unit 604.

1.7 Operations of Information Distribution System

(1) Operations for Transmitting Sponsor Information to Sponsor Card 200

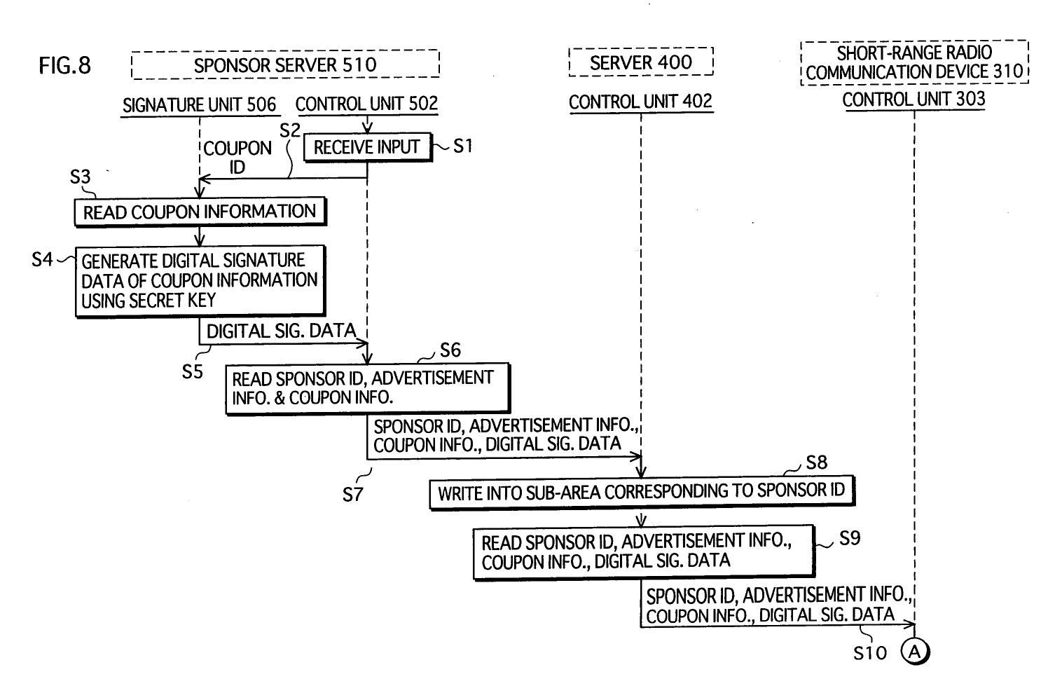

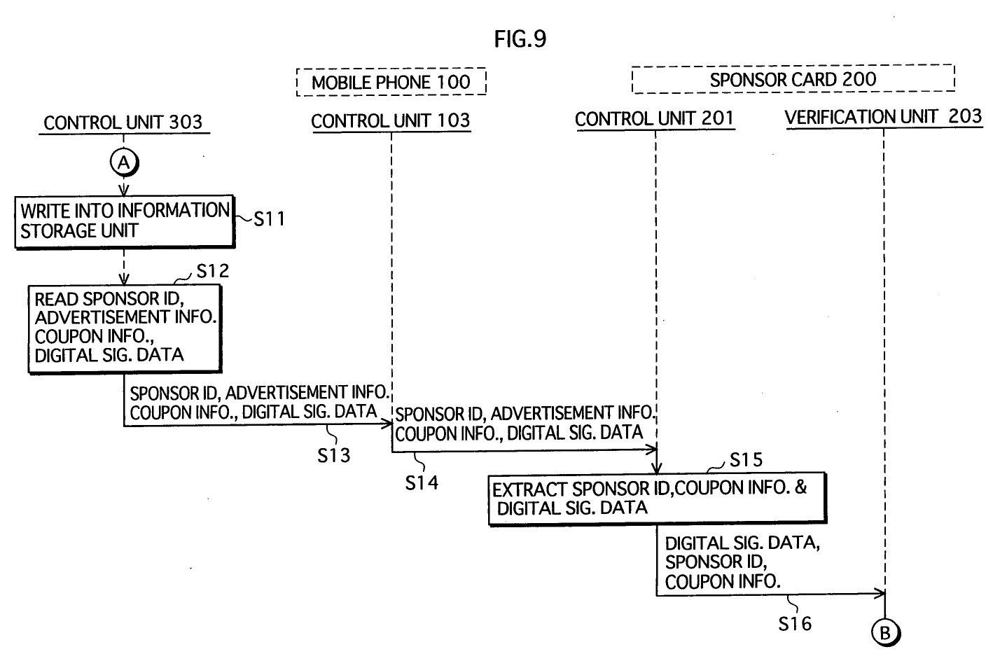

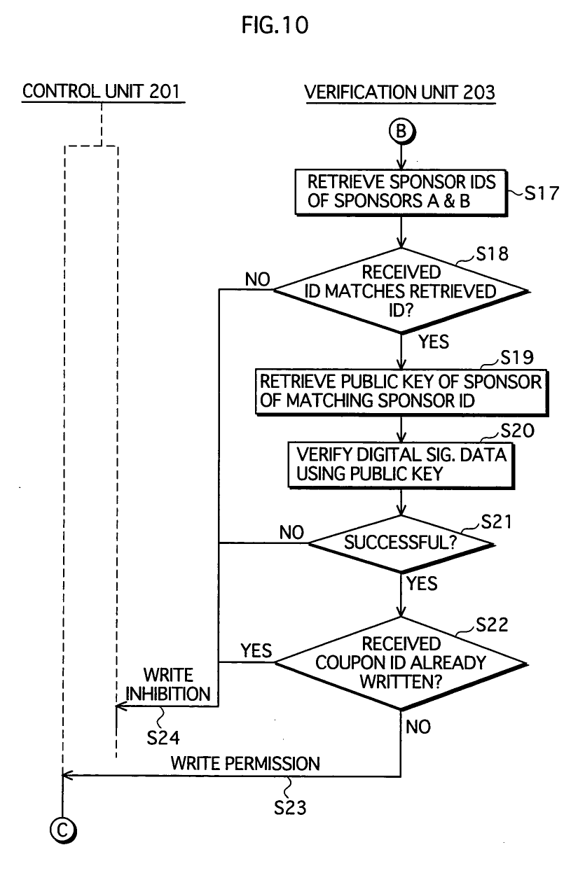

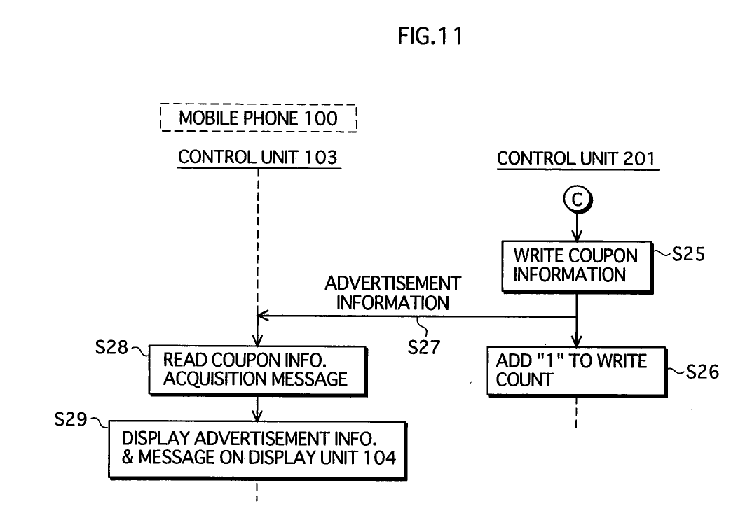

First, description is given with reference to FIGS. 8-11, to operations performed for transmitting information regarding a sponsor to the sponsor card 200.

The control unit 502 of the sponsor server 510 receives from the input unit 503, an instruction to transmit information (step S1), and then instructs the signature unit 506 to generate digital signature data (step S2).

In response, the signature unit 506 reads coupon information from the information storage unit 505 (step S3), generates digital signature data of the coupon information using a secret key (step S4), and outputs the generated digital signature data to the control unit 502 (step S5).

On receiving the digital signature data, the control unit 502 reads the sponsor ID, the advertisement information, and the coupon information from the information storage unit 505 (step S6), and transmits the read sponsor ID, advertisement information, and coupon information along with the digital signature data to the server 400 via the transmission/reception unit 501 (step S7).

The control unit 402 of the server 400 receives the sponsor ID, advertisement information, coupon information, and digital signature data via the transmission/reception unit 401, and writes the received information into a sub-area of the information storage unit 405 that is identified by the received sponsor ID (step S8)

The control unit 402 regularly reads the sponsor ID, advertisement information, coupon information, and digital signature from the information storage unit 405 (step S9), and transmits the read information to the short-range radio communication device 310 via the transmission/reception unit 401 (step S10).

The control unit 303 of the short-range radio communication device 310 receives the sponsor ID, advertisement information, coupon information, and digital signature data via the transmission/reception unit 305, and writes the received information into the information storage unit 304 (step S11).

The control unit 303 regularly reads the sponsor ID, advertisement information, coupon information, and digital signature data (step S12), and transmits the read information via the short-range radio transmission/reception unit 302 and the short-range radio antenna 301 (step S13).

The control unit 103 of the mobile phone 100 receives the sponsor ID, advertisement information, coupon information, and digital signature data via the short-range radio antenna 109 and the short-range radio transmission/reception unit 110. The control unit 103 then sends the received information to the sponsor card 200 via the interface 111 (step S14).

The control unit 201 of the sponsor card 200 extracts the sponsor ID, coupon information and digital signature data from the received information (step S15), and sends the extracted information to the verification unit 203 (step S16). The verification unit 203 then retrieves the sponsor IDs of the sponsors A and B (step S17), and verifies whether the received sponsor ID matches either of the retrieved sponsor IDs (step S18). When there is a match (step S18: Yes), the control unit 201 retrieves a public key of the sponsor identified by the matching sponsor ID (step S19), and verifies if the received digital signature data is valid using the retrieved public key (step S21) The verification unit 203 then judges whether the verification is successful (step S21) When the verification is successful (step S21: Yes), the verification unit 203 verifies whether any of the coupon IDs of coupon information stored in the information storage unit 202 matches the received coupon ID (step S22). When none of the stored coupon IDs matches the received coupon ID (step S22: No), the verification unit 203 outputs, as a verification result, write permission to the control unit 201 (step S23).

When the received sponsor ID does not match any of the retrieved sponsor IDs (step S18: No), when the verification is not successful (step S21: No), or when the received coupon ID is already stored in the information storage unit 202 (step S22: Yes), the verification unit 203 outputs, as a verification result, write inhibition to the control unit 201 (step S24).

On receiving write permission as the verification result, the control unit 201 writes the coupon information into the sponsor area 204 of the information storage unit 202 (step S25), and adds “1” to a corresponding write count (step S26). The control unit 201 sends the advertisement information to the mobile phone 100 (step S27).

On receiving the advertisement information via the interface 111, the control unit 103 of the mobile phone 100 reads the coupon information acquisition message from the information storage unit 108 (step S28), and then controls the display unit 104 so as to display the read message and the received advertisement information (step S29).

(2) Operations for Use of Coupon Information at Shop 600

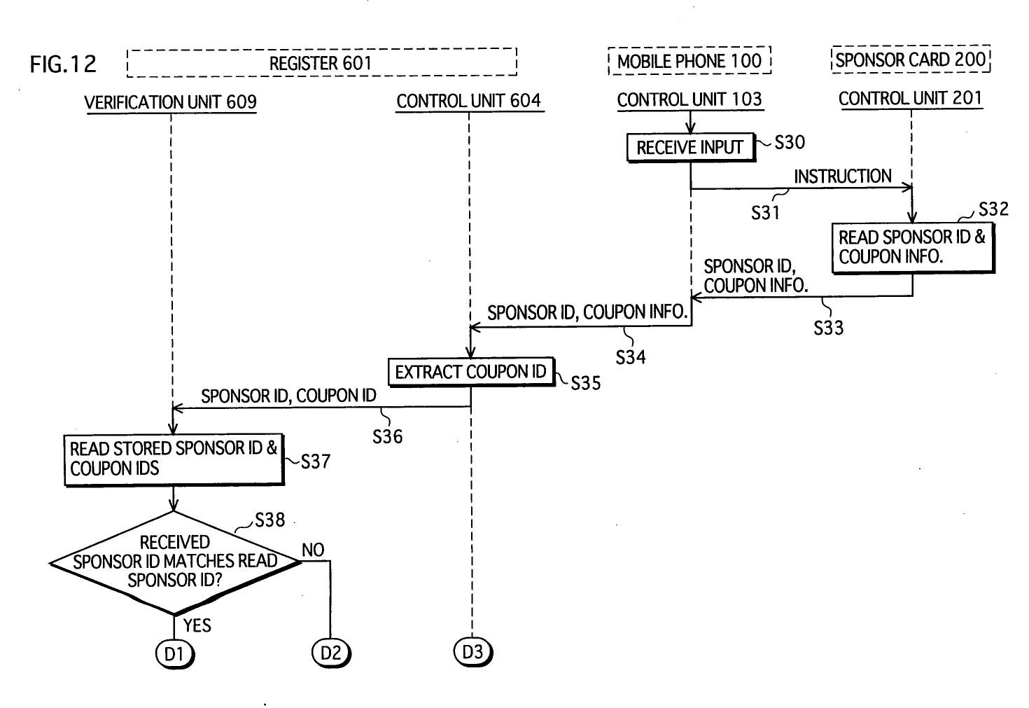

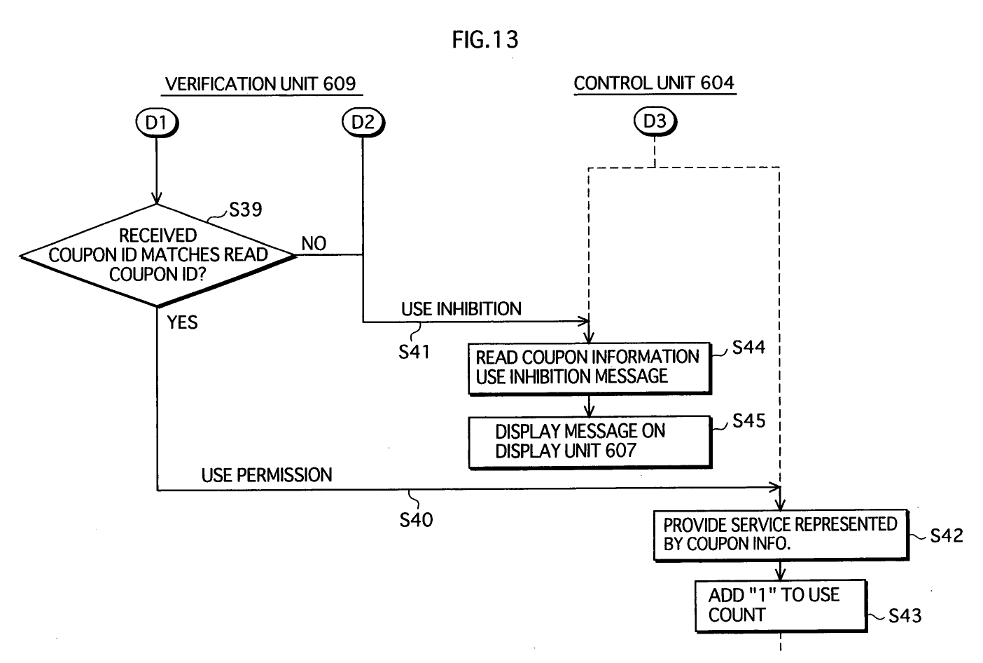

Now, description is given, with reference to FIGS. 12 and 13, to operations performed when the user uses coupon information at the shop 600.

The control unit 103 of the mobile phone 100 receives from the input unit 106, a coupon ID as an instruction to read a corresponding piece of coupon information and a corresponding sponsor ID from the sponsor card 200 (step S30), and then sends the instruction to the sponsor card 200 (step S31).

In response, the control unit 201 of the sponsor card 200 reads the sponsor ID and the coupon information having a coupon ID that matches the instructed coupon ID, and sends the read sponsor ID and coupon information to the mobile phone 100 (step S33).

The control unit 103 of the mobile phone 100 receives the sponsor ID and coupon information, and transmits the received sponsor ID and coupon information to the register 601 via the short-range radio transmission/reception unit 110 and the short-range radio antenna 109 (step S34).

The control unit 604 of the register 601 receives the sponsor ID and coupon information. The control unit 604 then extracts a coupon ID from the received coupon information (step S35), and sends the received sponsor ID and the extracted coupon ID to the verification unit 609 (step S36).

On receiving the sponsor ID and coupon ID, the verification unit 609 reads the sponsor ID and coupon IDs stored in the information storage unit 605 (step S37). The verification unit 609 then verifies whether the received sponsor ID matches the read sponsor ID (step S38). When the two sponsor IDs match (step S38: Yes), the verification unit 609 further verifies whether the received coupon ID matches any of the read coupon IDs (step S39) . When there is a match (step S39: Yes), the verification unit 609 outputs as a verification result, use permission to the control unit 604 (step S40) . When the received sponsor ID does not match the read sponsor ID (step S38: No), or when the received coupon ID matches none of the read coupon IDs (step S39: No), the verification unit 609 outputs, as a verification result, use inhibition to the control unit 604 (step S41).

When receiving use permission as the verification result, the control unit 604 operates so as to provide a service represented by the coupon information to the user (step S42), and adds “1” to the use count (step S43). On the other hand, when receiving use inhibition as the verification result, the control unit 604 reads from the information storage unit 605, a message informing that the coupon information is not usable (step S44), and controls the display unit 607 to display the read message (step S45).

(3) Operations for Transmitting Write Count of Coupon Information to Server 400

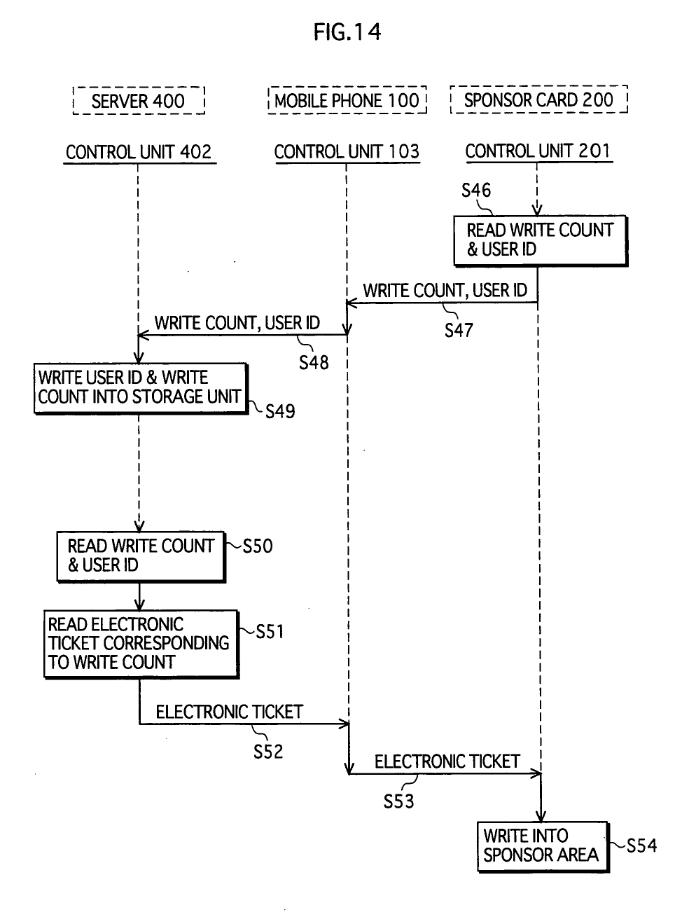

Next, description is given, with reference to FIG. 14, to operations performed for transmitting a write count of coupon information to the server 400.

The control unit 201 of the sponsor card 200 reads, separately for each sponsor, the write count and the user ID (step S46), and sends the read write count and user ID along with the sponsor ID to the mobile phone 100 (step S47).

The control unit 103 of the mobile phone 100 receives the write count, user ID, sponsor ID via the interface 111, and transmits the received write count, user ID, and sponsor ID to the server 400 via the transmission/reception unit 102 and the antenna 101 (step S48).

The control unit 402 of the sever 400 receives the write count, user ID, and sponsor ID, and then writes the user ID, the sponsor ID, and write count into the information storage unit 405 in association with one another (step S49).

At a later time, the control unit 402 reads a user ID and a corresponding write count from the user area 407 (step S50). In addition, the control unit 402 reads from the electronic table 408, an amount of monetary value that corresponds to the read write count (step S51), and then transmits via the transmission/reception unit 401, an electronic ticket having the read monetary value to the mobile phone that is identified by the user ID (step S52).

The control unit 103 of the mobile phone 100 receives the electronic ticket via the antenna 101 and transmission/reception unit 102, and sends the received electronic ticket to the sponsor card 200 (step S53). The control unit 201 of the sponsor card 200 receives the electronic ticket and writes the received electronic ticket into the sponsor area (step S54).

(4) Operations for Transmitting Use Count from Register 601 to Sponsor Server 510

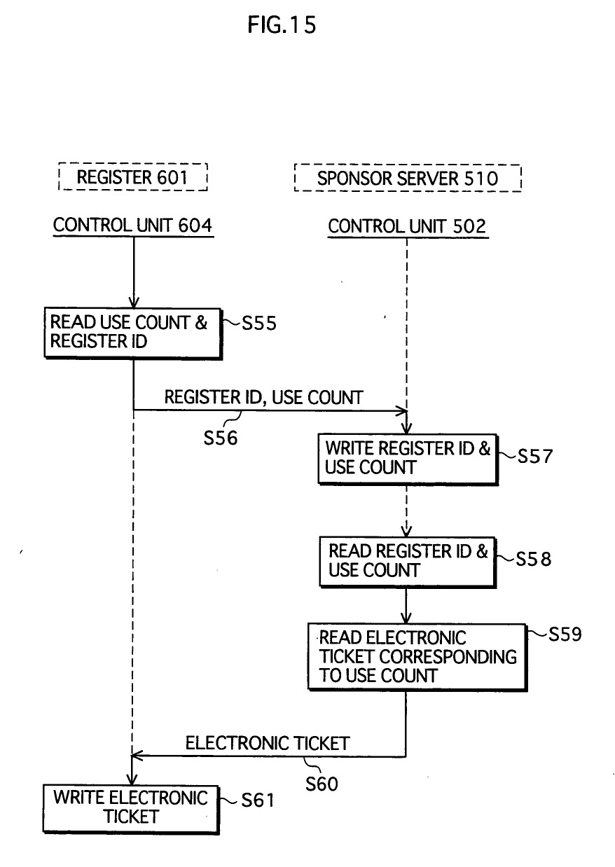

Now, description is given, with reference to FIG. 15, to the operations performed for transmitting the use count from the register 601 to the sponsor sever 510.

The control unit 604 of the register 601 reads the use count and the register ID from the information storage unit 605 (step S55), and transmits the read use count and register ID to the sponsor server 510 (step S56).

The control unit 502 of the sponsor server 510 receives the use count and register ID, and writes the received register ID and use count in association with each other into the information storage unit 505 (step S57).

The control unit 502 reads a register ID and a corresponding use count from the use count table 507 (step S58), and reads from the electronic ticket table 508, a monetary value that corresponds to the read use count (step S59). The control unit 502 then transmits via the transmission/reception unit 501, an electronic ticket having the read monetary value to the register that is identified by the read register ID (step S60).

The control unit 604 of the register 601 receives the electronic ticket via the transmission/reception unit 401, and writes the received electronic ticket to the information storage unit 605 (step S61).

2. Modifications

Note that the term “commodity” used in this specification includes stocks, futures, and services.

Up to this point, the present invention has been described by way of the embodiment. Yet, it should be appreciated that the present invention is in no way limited to the specific embodiment described above, and various modifications as follows still fall within the scope of the present invention.

(1) It is applicable to generate digital signature data from advertisement information or coupon information in part or in entirety.

(2) When storing coupon information into the information storage unit 202, the sponsor card 200 may send advertisement information to the mobile phone 100, so that the mobile phone displays the advertisement information while the information storage unit 202 stores the coupon information.

When the control unit 103 of the mobile phone 100 reads the coupon information, the control unit 103 also reads the advertisement information, so that the display unit 104 displays the coupon information as well as the advertisement information.

(3) The short-range radio communication device 310 may transmit a sponsor ID alone prior to advertisement information and coupon information.

On receiving the sponsor ID via the short-range radio antenna 109 and the short-range radio transmission/reception unit 110, the control unit 103 of the mobile phone 100 sends the received sponsor ID to the sponsor card 200 via the interface 111.

On receiving the sponsor ID, the control unit 201 of the sponsor card 200 sends the received sponsor ID to the verification unit 203.

On receiving the sponsor ID, the verification unit 203 retrieves the sponsor IDs of the sponsors A and B, and verifies whether the received sponsor ID matches either of the retrieved sponsor IDs. When the received sponsor ID does not match any of the sponsor IDs, the verification unit 203 instructs the control unit 103 of the mobile phone 100 not to receive the advertisement information and coupon information. On the other hand, when there is a match, the verification unit 203 instructs the control unit 103 to receive the advertisement information and coupon information.

On receiving the coupon information and advertisement information from the short-range radio communication device 310, the control unit 103 reads from the information storage unit 108, a message informing acquisition of coupon information, and instructs the display unit 104 to display the read message along with the advertisement information. The coupon information is sent to the sponsor card 200 via the interface 111.

The control unit 201 of the sponsor card 200 writes the received coupon information into the sponsor area 204 of the information storage unit 202.

(4) According to the modification (3) described above, the sponsor card 200 performs verification of a sponsor before receiving advertisement information and coupon information. The verification may be performed as follows.

The verification unit 203 of the sponsor card 200 stores a public key PK_A of the sponsor.

The short-range radio communication device 310 further includes a signature unit (not illustrated) that stores a secret key SK_A of the sponsor.

The control unit 303 transmits an authentication request to the mobile phone 100 via the short-range radio transmission/reception unit 302 and the short-range radio antenna 301 before transmitting advertisement information or coupon information.

The control unit 103 of the mobile phone 100 transmits the received authentication request via the short-range radio antenna 109 and the short-range radio transmission/reception unit 110, and sends the received authentication request to the sponsor card 200 via the interface 111.

On receiving the authentication request, the control unit 201 of the sponsor card 200 instructs the verification unit 203 to generate a random number Cha, and transmits the generated random number Cha to the mobile phone 100. The control unit 103 of the mobile phone 100 transmits the random number Cha to the short-range radio communication device 310 via the short-range radio transmission/reception unit 110 and the short-range radio antenna 109.

On receiving the random number Cha, the control unit 303 of the short-range radio communication device 310 sends the received random number Cha to the signature unit. Upon receipt, the signature unit generates digital signature data SIG of the random number Cha using the secret key SK_A, and transmits the generated digital signature data SIG to the mobile phone 100.

The control unit 103 of the mobile phone 100 receives the digital signature data SIG via the short-range radio antenna 109 and the short-range radio transmission/reception unit 110, and sends the received digital signature data SIG to the sponsor card 200.

The control unit 201 of the sponsor card 200 receives the digital signature data SIG and sends the received digital signature data SIG to the verification unit 203. The verification unit 203 then verifies using the public key PK_A, if the received digital signature data SIG is valid, and outputs a result showing whether the verification is successful or not to the control unit 201.

When the verification is successful, the control unit 201 transmits to the mobile phone 100, permission for receiving the advertisement information and coupon information. With the receive permission, the mobile phone 100 receives the coupon information and advertisement information in the similar manner to the modification (3). When the verification fails, the mobile phone 100 does not receive the advertisement information and coupon information.

(5) According to the above modification (4), each short-range radio communication device that transmits information of the sponsor A stores an identical secret key of the sponsor A. Yet, a modification as follows is applicable.

The signature unit 506 of the sponsor server 510 stores a secret key SK_A of the sponsor A and a public key PK_H of the short-range radio communication device 310.

The short-range radio communication device 310 stores, in the signature unit, a secret key SK_H of the short-range radio communication device 310.

The sponsor card 200 stores, in the verification unit 203, a public key PK_A of the sponsor A.

The signature unit 506 of the sponsor server 510 generates digital signature data Cert_H of the public key PK_H using the secret key SK_A, and outputs the generated digital signature data Cert_H to the control unit 502. The control unit 502 transmits the public key PK_H and the received digital signature data Cert_H to the short-range radio communication device 310 via the transmission/reception unit 501.

The control unit 303 of the short-range radio communication device 310 receives the public key PK_H and the digital signature data Cert_H via the transmission/reception unit 305, and writes the received public key PK_H and signature data Cert_H into the information storage unit 304.

Prior to every transmission of information to the mobile phone 100, the control unit 303 of the short-range radio communication device 310 reads the public key PK_H and the digital signature data Cert_H from the information storage unit 304, and transmits the read public key PK_Hand digital signature data Cert_H via the short-range radio transmission/reception unit 302 and the short-range radio antenna 301.

The control unit 103 of the mobile phone 100 receives the public key PK_H and the digital signature data Cert_H via the short-range radio antenna 109 and the short-range radio transmission/reception unit 110, and sends the public key PK_H and the digital signature data Cert_H to the sponsor card 200.

In response, the control unit 201 of the sponsor card 200 sends the received public key PK_H and digital signature data Cert_H to the verification unit 203. The verification unit 203 then retrieves the public key PK_A stored therein and verifies if the digital signature data Cert H is valid using the retrieved public key PK_A. The verification unit 203 then outputs whether the verification is successful or not to the control unit 201.

When the verification is successful, the control unit 201 instructs the mobile phone 100 to receive the advertisement information and coupon information. Otherwise, the mobile phone 100 does not receive the advertisement information and coupon information.

(6) Although a public key cryptography is employed in the above modifications (4) and (5), the verification between the short-range radio communication device 310 and the sponsor card 200 may be performed by sharing a common key.

To this end, the control unit 303 of the short-range radio communication device 310 further includes a signature unit (not illustrated) . The signature unit and the verification unit 203 of the sponsor card 200 store a common key Kc_A.

Before the short-range radio communication device 310 performs data transmission with the mobile phone 100, the control unit 303 transmits an authentication request to the mobile phone 100 via the short-range radio transmission/reception unit 302 and the short-range radio antenna 301.

The control unit 103 of the mobile phone 100 receives the authentication request via the short-range radio antenna 109 and the short-range radio transmission/reception unit 110, and sends the received authentication request to the sponsor card 200 via the interface 111.

On receiving the authentication request, the control unit 201 of the sponsor card 200 generates a random number Cha and sends the generated random number Cha to the mobile phone 100.

The control unit 103 then transmits the received random number Cha to the short-range radio communication device 310 via the short-range radio transmission/reception unit 110 and the short-range radio antenna 109.

On receiving the random number Cha, the control unit 303 of the short-range radio communication device 310 sends the received random number Cha to the signature unit. On receiving the random number Cha, the signature unit encrypts the random number Cha using the common key Kc_A to generate Res, which is an encrypted random number Cha, and outputs Res to the control unit 303. Then, the control unit 303 transmits Res to the mobile phone 100 via the short-range radio transmission/reception unit 302 and the short-range radio antenna 301.

The control unit 103 receives Res via the short-range radio antenna 109 and the short-range radio transmission/reception unit 110, and sends Res to the sponsor card 200 via the interface 111.

On receiving Res, the control unit 201 sends Res to the verification unit 203. On receiving Res, the verification unit 203 retrieves the common key Kc_A stored therein, and decrypts Res using the common key Kc_A to verifies whether the decrypted data matches the originally generated random number Cha.

(7) The above modification (6) may be further modified as follows. To verify if Res is valid, the verification unit 203 retrieves the common key Kc_A and encrypts the random number Cha to verify whether the encrypted Cha matches Res.

(8) In the above modifications (3)-(7), it is the signature unit of the short-range radio communication device 310 that generates digital signature data or encrypted data. However, it is applicable that the signature unit 506 of the sponsor server 510 generates digital signature data or encrypted data.

(9) In the above embodiment and modifications (3)-(7), the verification is performed by the sponsor card 200. However, it is possible that the mobile phone 100 performs the verification. In this case, the information storage unit 202 of the sponsor card 200 stores, for each sponsor, a sponsor ID, a public key, a common key in a manner that the stored information is not rewritable.

(10) Communications between the short-range radio communication unit 310 and the mobile phone 100 maybe performed not only by short-range radio communication, but also by other communication means, such as wireless IP communication.

(11) The sponsor card 200 may be provided to a user from a card provider by lease.

In this case, the control unit 201 of the sponsor card 200 keeps, in the information storage unit 202, a count of how many times coupon information is written. The control unit 201 regularly transmits, via the mobile phone 100, the write count to a server of the card provider.

The card provider makes a discount on the lease fee according to the write count.

(12) The discount made in the above modification (11) is compensated for by the sponsor of the sponsor card 200.

(13) In the above modification (11), the card provider may additionally provide a sponsor card to the user depending on the write count.

(14) In the above modification (11), the card provider may exchange, depending on the write count, the sponsor card 200 used by the user with another sponsor card having a lager capacity.

(15) The card provider may provide to a user a memory card that is not yet sponsored.

In this case, the user registers on a WEB site, the user name and other information so as to designate the memory card as the sponsor card 200 that is sponsored by the sponsor A. Thereafter, the same procedure is performed as in the modification (11).

(16) When there is a plurality of sponsors for the sponsor card 200, the sponsors may be assigned priorities.

Consequently, when there is not enough free space left in the sponsor area 204 of the information storage unit 202 for writing received coupon information, the control unit 201 writes the received coupon information by overwriting previously stored coupon information that is issued by the lowest priority sponsor.

(17) The control unit 201 may measure a date/time when coupon information is received, and write coupon information into the sponsor area together with the measured receiving date/time.

Consequently, when there is not enough free space left in the sponsor area 204, the control unit 201 writes received coupon information by overwriting previously stored coupon information of which receiving date/time is the earliest of all.

(18) When there is not enough free space left in the sponsor area 204, the control unit 201 may allows the user to select which of the previously stored coupon information is to be overwritten by received coupon information.

(19) The sponsor A may assign priorities to each piece of coupon information to be transmitted.

Consequently, when there is no enough free space left in the sponsor area 204, the control unit 201 records received coupon information by overwriting on previously recorded coupon information that is lowest in the assigned priority.

(20) There maybe a case where enough space is not assured even after selecting previously stored coupon information as descried in the above modification (16). In such a case, the control unit 201 additionally selects previously stored coupon information having a lower priority than the received coupon information and writes the received coupon information by overwriting the selected coupon information.

(21) The sponsor A may set an expiry date/time for each piece of coupon information to be transmitted. Consequently, the control unit 201 stores received coupon information and deletes the coupon information at the expiry.

(22) The control unit 201 may write received coupon information along with the receiving date/time, and deletes the coupon information after a predetermined date/time passes since the receiving date/time.

(23) In the above embodiment, the short-range radio communication device 310 transmits an ID identifying a sponsor. Alternatively, the short-range radio communication device 310 may transmit an ID identifying types of advertisement information or of service represented by coupon information.

(24) In the above embodiment, at least one sponsor bears at least part of the cost of the sponsor card 200, so that the sponsor card 200 is provided to a user at no or lower cost than would otherwise be fully payable by the user. However, it is also applicable that the card provider provides a memory card that is not yet sponsored to a user at a lower price. In this case, the user receives advertisement information and coupon information of the card provider, or designates the memory card as a sponsor card of a sponsor in the similar manner to the above modification (15).

Further, an advertisement agent may bear the cost of a memory card partly, and transmit to the memory card, advertisement information of corporations that are clients of the advertisement agent.

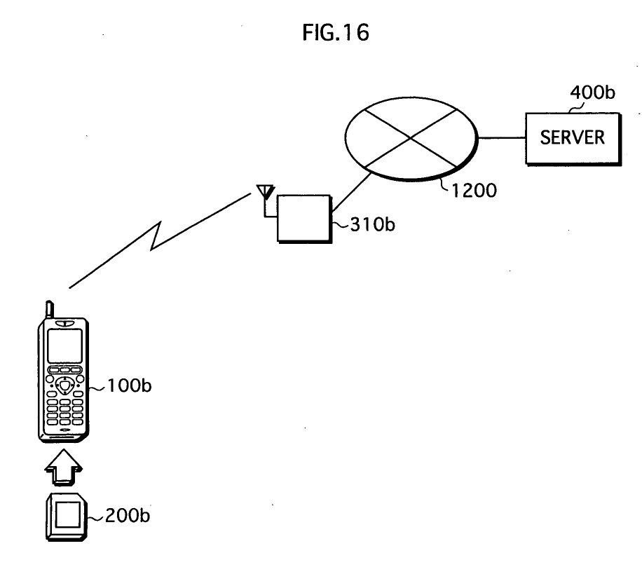

(25) The present invention may be structured so as to allow the user to refuse to write undesired information. Further, the sponsor may select information to be transmitted thereafter to the user based on the refused information. One example of such a modification is described hereinafter with reference to FIGS. 16-20. Note that FIG. 16 only shows the structures that are necessary for the sponsor card to acquire information and for the sponsor to acquire the information refused by the user.

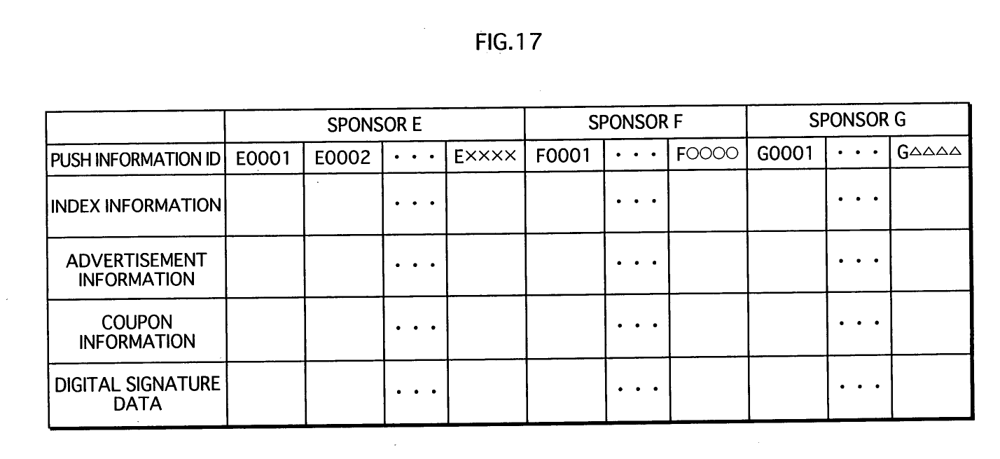

In FIG. 16, a server 400b is owned by an advertisement agent that is contracted to handle advertising of sponsors E, F, and G. The server 400b stores in a sponsor area 406b, a PUSH information list shown in FIG. 17. The PUSH information list contains pieces of PUSH information separately for each sponsor. Each piece of PUSH information is composed of a PUSH information ID, index information, advertisement information, coupon information, and digital signature data. The index information is general information of the advertisement information and coupon information and used to inform the user of the content. The PUSH information ID uniquely identifies the PUSH information. Note that that PUSH information list in FIG. 17 only shows the data structure without actual content of the PUSH information.

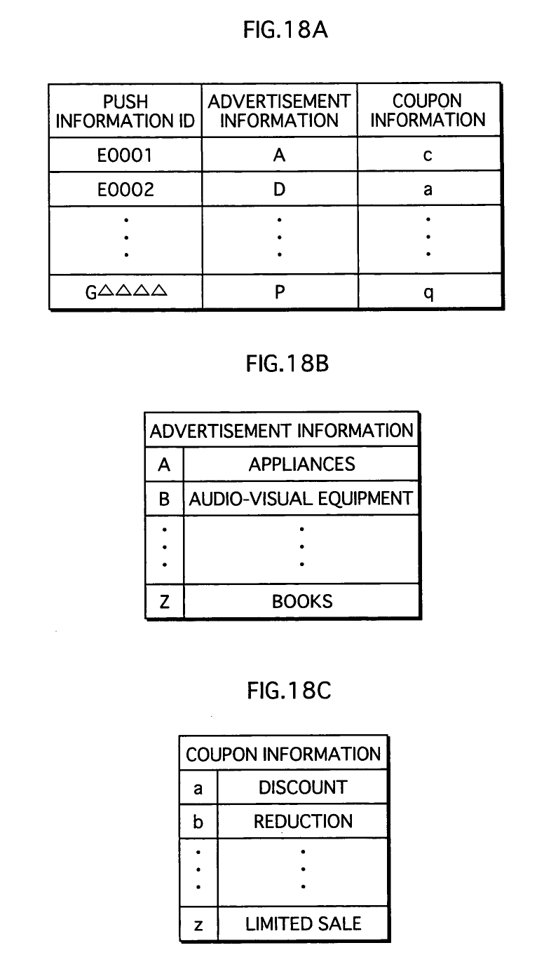

Further, the server 400b stores category tables as shown in FIGS. 18A, 18B, and 18C showing categories into which PUSH information is classified.

The category tables in FIGS. 18B and 18C show categories of advertisement information and coupon information, respectively. The category table FIG. 18A shows PUSH information IDs each along with a corresponding combination of an advertisement information category and a coupon information category.

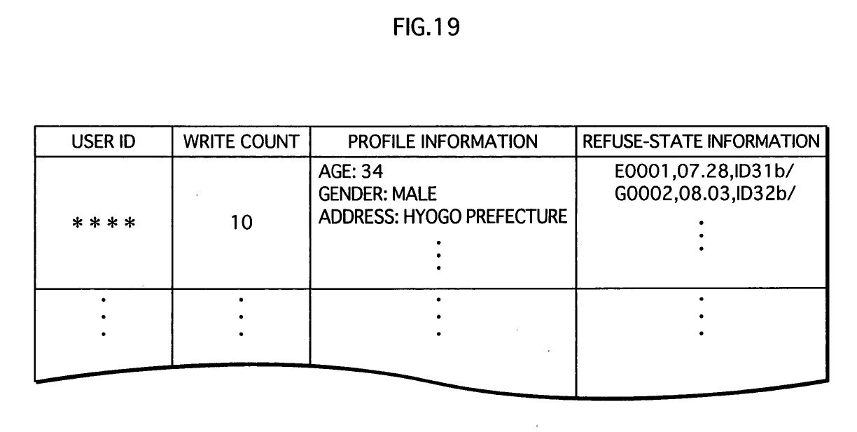

Further, as shown in FIG. 19, the server 400b has a user area 407b storing, for each user, a user ID and a write count similar to the above embodiment in addition to profile information and refuse-state information. The profile information is information regarding the user and is registered at the time of user ID registration. For example, the profile information includes user's age, gender, and address. In an area for the refuse-state information, refuse-state information that is regularly sent from the sponsor card 200b is accumulated. The refuse-state information shows PUSH information having been refused by the user. To be more specific, the refuse-state information shows, for each piece of refused PUSH information, a PUSH information ID, a date/time at which the push information is transmitted to the sponsor card, and an ID of the short-range radio communication device being the transmission source.

The short-range radio communication device 310b shown in FIG. 16 stores a unique ID of “ID31b”.

Since the advertisement agent bears a part of the cost, the sponsor card 200b shown in FIG. 16 is provided to a user at a lower cost to the user than would otherwise be fully payable by the user. The sponsor card 200b has, in the sponsor area, an area for storing refuse-state information. The sponsor card 200b acquires a piece of refuse-state information that includes a PUSH information ID and a radio communication device ID, and also acquires a date/time that is measured by the mobile phone 100b at the time of acquiring the PUSH information. The sponsor card 200b then stores the acquired PUSH information ID, radio communication device ID, and the date in association with one another. The sponsor card 200b monthly transmits the acquired refuse-state information to the server 400b.

Further, the sponsor card 200b stores in advance a permissive refuse count showing a number of times that the sponsor card 200b is allowed to refuse PUSH information. The sponsor card 200b also stores a refuse count showing how many times PUSH information has been refused.

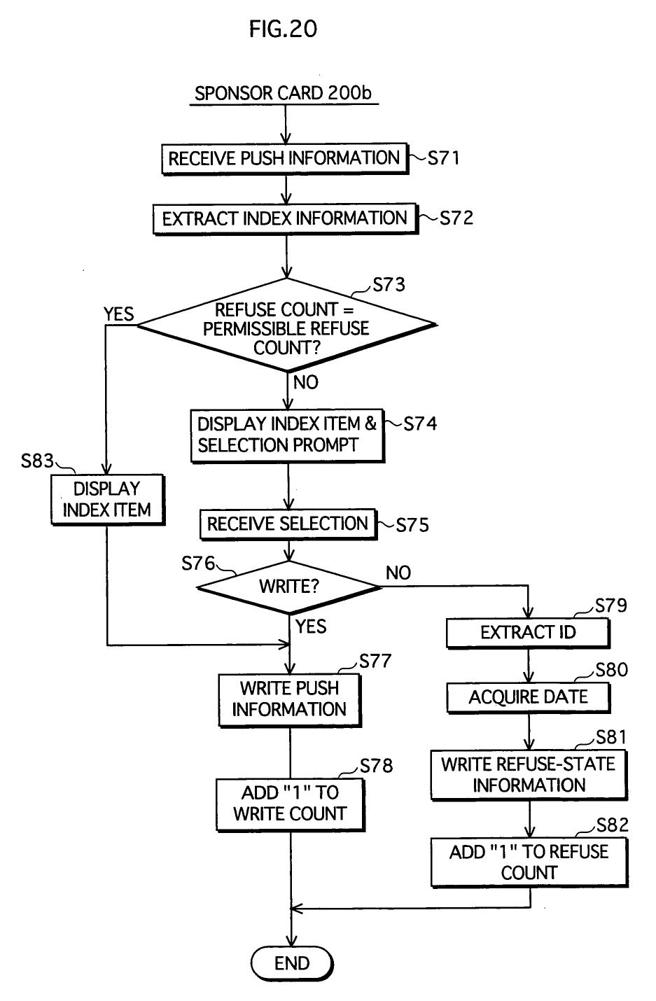

Hereinafter, with reference to FIG. 20, description is given to operations performed for transmitting PUSH information from the server 400b to the sponsor card 200b.

The server 400b transmits PUSH information to the short-range radio communication device 310b.

The short-range radio communication device 310b receives and stores the PUSH information. When transmitting the PUSH information, the short-range radio communication device 310b also transmits “ID31b” as appendix to the PUSH information.

On receiving the PUSH information (step S71), the sponsor card 200b extracts index information from the received PUSH information (step S72), and judges whether the refuse count is equal to the permissible refuse count (step S73).

When the refuse count is not equal to the permissible refuse count (step S73: No), the sponsor card 200b controls the mobile phone 100b so that the display unit of the mobile phone 100b displays the extracted index information and a message prompting user to select whether to write or refuse the received PUSH information (step S74). The sponsor card 200b receives a user selection via the mobile phone 100b (step S75). On receiving a selection to write the received PUSH information (step S76: YES), the sponsor card 200b writes the received PUSH information into the sponsor area (step S77), and adds “1” to the write count (step S78). On the other hand, on receiving a selection to refuse to write the received PUSH information (step S76: NO), the sponsor card 200b extracts a PUSH information ID and the ID “ID31b” identifying the short-range radio communication device being the transmission source (step S79), and also acquires from the mobile phone 100b, a date/time at which the PUSH information is received (step S80). The sponsor card 200b then stores, as refuse-state information, the extracted PUSH information ID along with the ID “ID31b” and the acquired receiving date/time (step S81). Further, the sponsor card 200b adds “1” to the refuse count (step S82)., On the other hand, when the refuse count is equal to the permissible refuse count (step S73: YES), the sponsor card 200b is no longer allowed to refuse to write the received PUSH information. Consequently, the sponsor card 200b controls the mobile phone 100b so that the display unit of the mobile phone 100b displays the index information (step S83), and writes the received PUSH information into the sponsor area (step S77). The sponsor card 200b then adds “1” to the write count (step S78).

In the manner described above, the user is allowed to refuse undesired PUSH information within a predetermined ratio.

Now, description is given to operations performed for transmitting refuse-state information from the sponsor card 200b to the server 400b.

The sponsor card 200b regularly transmits the refuse-state information along with the user ID to the server 400b via the short-range radio communication device 310b. After every transmission of the refuse-state information, the sponsor card 200b deletes the refuse-state information form the sponsor area and resets the refuse count to “0”.

The short-range radio communication device 310b transmits the received refuse-state information to the server 400b.

The server 400b writes the received refuse-state information into the user area. In addition, the server 400b analyzes the profile information corresponding to the user ID as well as categories shown in the category tables corresponding to the PUSH information ID included in the received refuse-state information. In accordance with the analysis, the server 400b determines PUSH information to be transmitted in the future, a short-range radio communication device to which PUSH information is to be transmitted, and a time of day during which PUSH information is to be transmitted.

Note that the ratio within which the sponsor card is allowed to refuse PUSH information may be determined in terms of the number of times out of received number of times, rather than the number of times in a particular period of time.

Further, instead of transmitting refuse-state information on a regular basis, i.e. at a regular interval, the sponsor card 200b may transmit refuse-state information when the refuse count exceeds a predetermined number of times.

Further, the sponsor card 200b may transmit refuse-state information to whichever short-range radio communication device that is at the closest location, rather than always to the short-range radio communication device 310b. With this arrangement, when many more short-range radio communication devices are newly located in the future, there is no need for the user to bring the mobile phone 100b and the sponsor card 200b to the vicinity of the short-range radio communication device 310a. Instead, the user will be allowed to transmit refuse-state information to the server 400b via any short-range radio communication device that is located closest to the user among a number of short-range radio communication devices.

Further, the sponsor card 200b may transmit refuse-state information to the short-range radio communication device at the time when receiving a next piece of PUSH information. Alternatively, the sponsor card 200b may transmit refuse-state information to a register at a shop along with coupon information at the time when the user uses the coupon information. In response, the register transmits the received refuse-state information to the server 400b. Alternatively, the sponsor card 200b may transmit refuse-state information to the server 400b at the time of transmitting a write count.

In the above modification, the profile information is stored in the server 400b. However, the profile information may be stored in the sponsor card 200b and transmitted to the server 400b at the time of transmitting refuse-state information.

Further, in addition to refuse state information, the sponsor card 200b may transmit information related to PUSH information having been accepted and written to the sponsor card 200b.

Further, it is applicable that the sponsor card 200b automatically judges whether to write or refuse received PUSH information in the following manner.

To this end, each PUSH information ID includes type information showing the category of the PUSH information. Consequently, the sponsor card 200b judges whether to refuse newly received coupon information based on type information that is included in PUSH information IDs that are already stored as refuse-state information.

It is not necessary that the server 400b stores category tables of PUSH information. Similarly to the above, in this case, the server 400b determines PUSH information to be transmitted based on type information that is included in PUSH information IDs.

Further, coupon information and advertisement information may both be identified by their respective IDs, and classified in more detailed categories than a type.

Further, the sponsor card 200b may transmit, along with refuse-state information, PUSH information IDs corresponding to PUSH information that is once stored but deleted without being used as coupon information by the user.

(26) The present invention may be embodied as methods shown above. Further, each of the methods may be a computer program run by a computer, or a digital signal representing the computer program.

Further, the present invention may be embodied as a computer-readable recording medium storing the computer program or the digital signal. Examples of such a recording medium include a flexible disk, a hard disk, CD-ROM, MO, DVD, DVD-ROM, DVD-RAM, BD (Blu-ray Disc) and a semiconductor memory. Further, the present invention may be embodied as the computer program or the digital signal recorded on any recording medium mentioned above.

Further, the present invention may be embodied as the computer program or the digital signal transmitted via an electric communication line, wireless communications, a wired communication line, or a network typified by the Internet.

Further, the present invention may be embodied as a computer system composed of a microprocessor and memory. The memory stores the computer program mentioned above. The microprocessor may operate according to the computer program.

Further, the program or the digital signal may be transferred in form of a recording medium mentioned above, or via a network mentioned above, so that the program or the digital signal may be executed by another independent computer system.

(27) The present invention may be any combination of the above-described embodiment and modifications.

3. Effects of Present Invention

As has been described above, the present invention provides an information distribution system for distributing information from an information provider to a user. The information distribution system includes: an information distribution device for distributing commodity information that serves as an advertisement for a commodity; a communication terminal for receiving the commodity information, and outputting the received commodity information to a memory card; and the memory card that is portable and mounted on the communication terminal. Here, the memory card is provided to the user at a cost borne at least partly by the information provider, and includes: a storage unit having a storage area for commodity information; a judging unit operable to judge whether the received commodity information was issued from the information provider; and a writing unit operable, if the judgment is affirmative, to write the received commodity information to the commodity information storage area for a purpose of displaying to the user.

With this structure, the information provider bears the cost of the memory card, so that the memory card is provided to the user at lower cost than would otherwise be fully payable by the user.

Here, the memory card may output the received commodity information to the communication terminal if the judgment is affirmative. The communication terminal may receive the commodity information from the memory card and displays the received commodity information.

With this structure, the user is shown commodity information that is issued by the information provider bearing the cost of the memory card.

Here, the writing unit may output write-indicate information to the communication terminal if the judgment is affirmative, the write-indicate information indicating that the commodity information has been written. The communication terminal may transmit the received write-indicate information to the information distribution device. The information distribution device may receive the write-indicate information, generate an electronic ticket having a monetary value based on the received write-indicate information, and securely transmit the generated electronic ticket to the memory card via the communication terminal. The writing unit may write the received electronic ticket to the storage unit.

With this structure, the user receives the electronic ticket having the monetary value that is determined according to the write-indicate information. The user can use the received electronic ticket to exchange the current memory card to another memory card having a lager capacity or to acquire an additional memory card.

Here, the information distribution device may transmit the commodity information that includes coupon information showing a discount to be made on the commodity. The writing unit may write the commodity information that includes the coupon information. The memory card may transmit, when the user purchases the commodity, the coupon information via the communication terminal. The information distribution system may further include a payment settlement device for receiving the coupon information from the memory card via the communication terminal and making a discount on the commodity based on the received coupon information.

With this structure, the user transmits to the payment settlement device, the coupon information that is received from the information provider so as to receive discount on the commodity.

Here, the memory card may be provided to the user on a lease in return for regular payments of a lease fee to the information provider. The storage unit may store an electronic ticket having a monetary value. The memory card may securely transmit, on a regular basis, an electronic ticket having a monetary value equivalent to the lease fee to the information distribution device via the communication terminal, and deduct the transmitted monetary value from the electronic ticket stored in the storage unit.

With this structure, the user can lease the memory card by regularly transmitting an electronic ticket to the information distribution device.

Here, the memory card may reduce the lease fee on outputting the commodity information to the communication terminal for a purpose of displaying to the user, securely output an electronic ticket having a monetary value equivalent to the post-reduction lease fee to the communication terminal, and deduct the outputted monetary value from the electronic ticket stored in the storage unit.

With this structure, the user receives a discount on the lease fee in exchange for viewing commodity information displayed on the communication terminal.

In another aspect, the present invention provides to a user, a memory card that is for storing information transmitted from an information provider to the user, and that is portable and mounted on a communication terminal. The memory card includes: a storage unit having a storage area for commodity information issued from a specific information provider; a receiving unit operable to receive commodity information from an information distribution device via the communication terminal; a judging unit operable to judge whether the received commodity information was issued from the specific information provider; and a writing unit operable, if the judgment is affirmative, to write the received commodity information to the commodity information storage area for a purpose of displaying to the user.

Here, the memory card may output the received commodity information to the communication terminal if the judgment is affirmative. The communication terminal may receive the commodity information from the memory card and display the received commodity information.

Further, the commodity information storage area may store commodity information issued from the specific information provider that bears a cost of the memory card at least partly.

With this structure, the user is shown commodity information issued by the specific information provider bearing the cost of the memory card. In return, the user is provided the memory card at no or lower cost than would otherwise be fully payable by the user.

Here, the commodity information may include a first provider ID identifying an information provider that issued the commodity information. The receiving unit may receive the commodity information that includes the first provider ID. The judging unit may prestore a second provider ID identifying the specific information provider, extract the first provider ID from the received commodity information, and judge whether the received commodity information was issued from the specific information provider, by matching the first provider ID against the second provider ID. The writing unit may write the received commodity information to the commodity information storage area if the first and second provider IDs match.

With this structure, the memory card refers to an ID that identifies an information provider so as to selectively receive commodity information that is issued by the information provider bearing the cost of the memory card.

Here, the judging unit may prestore a public key of the specific information provider. The information distribution device may prestore a secret key of the specific information provider, generate digital signature data from the commodity information using the secret key, and transmit the generated digital signature data. The judging unit may receive the digital signature data via the communication terminal, and verify validity of the digital signature data using the public key to judge whether the commodity information was issued from the specific information provider. The writing unit may write the received commodity information to the commodity information storage area if the verification is successful.

With this structure, the memory card is capable of judging whether the received commodity information is issued by the information provider bearing the cost of the memory card, and whether the received commodity information has been tampered.

Here, the writing unit may transmit write-indicate information to the information distribution device via the communication terminal if the commodity information is judged to be issued from the specific information provider. The write-indicate information indicates that the commodity information has been written. The receiving unit may securely receive, via the communication terminal, an electronic ticket generated by the information distribution device. The electronic ticket has a monetary value based on the write-indicate information.

With this structure, the user receives the electronic ticket having the monetary value that is determined according to the write-indicate information. The user can use the received electronic ticket to exchange the current memory card to another memory card having a lager capacity or to acquire an additional memory card.

Here, the memory card may be provided to the user on a lease in return for regular payments of a lease fee to the specific information provider. The storage unit may store an electronic ticket having a monetary value. The receiving unit may securely transmits, on a regular basis, an electronic ticket having a monetary value equivalent to the lease fee to the information distribution device via the communication terminal, and deduct the transmitted monetary value from the electronic ticket stored in the storage unit.

With this structure, the user can lease the memory card by regularly transmitting an electronic ticket to the information distribution device.

Here, the receiving unit may receive the commodity information that includes a priority rank assigned thereto. The commodity information storage area may store commodity information that includes a priority rank assigned thereto. The writing unit may write, when enough free space is not left in the commodity information storage area, the received commodity information by overwriting previously stored commodity information that is lowest in priority rank.

With this structure, when enough free space is not left in the commodity information storage area, the memory card writes the received commodity information by overwriting previously written commodity information that is selected according to the priority ranks.

Here, the commodity information storage area may store commodity information in association with a receiving time of the commodity information. The writing unit may write, when enough free space is not left in the commodity information storage area, the received commodity information by overwriting previously stored commodity information having an earliest receiving time.

With this structure, when enough free space is not left in the commodity information storage area, the memory card writes the received commodity information by overwriting previously written commodity information that is selected in the order of the receiving times.

Here, the receiving unit may further receive another piece of commodity information issued from another information provider. Each piece of commodity information may include a priority rank assigned to a corresponding information provider. The writing unit may write, when enough free space is not left in the commodity information storage area, the other piece of commodity information by overwriting previously stored commodity information issued from an information provider having a lower priority rank.

With this structure, when enough free space is not left in the commodity information storage area, the memory card writes the received commodity information by overwriting previously written commodity information that is lower in priority rank than the received commodity information.

In another aspect, the present invention provides to a user, a memory card that is for storing information transmitted from an information provider to the user, and that is portable and mounted on a communication terminal. The memory card includes: a storage unit having a storage area for commodity information issued from a specific information provider; a first receiving unit operable to receive provider information from an information distribution device via the communication terminal, the provider information showing an information provider that issued commodity information to be received; a judging unit operable to judge based on the received provider information, whether the commodity information was issued from the specific information provider; a second receiving unit operable to receive the commodity information from the information distribution device via the communication terminal if the judgment is affirmative; and a writing unit operable to write the received commodity information to the commodity information storage area.

Here, the memory card may output, if the judgment is affirmative and thus receives the commodity information, the received commodity information to the communication terminal. The communication terminal may receive and display the commodity information.

Further, the commodity information storage area may store commodity information issued from the specific information provider that bears a cost of the memory card at least partly.

With this structure, the memory card receives only the commodity information that is issued by the information provider bearing the cost of the memory card, so that the memory card is provided to the user at no or lower cost than would otherwise be fully payable by the user.

Further, by the communication terminal displaying the commodity information received by the memory card, the user is shown the commodity information that is issued by the information provider bearing the cost of the memory card.

Here, the commodity information may be associated with a first provider ID identifying an information provider that issued the commodity information. The first receiving unit may receive the first provider ID as the provider information. The judging unit may judge whether the received first provider ID matches a second provider ID that identifies the specific information provider. The second receiving unit may receive the commodity information if the first and second provider IDs match.

With this structure, the memory card judges whether the received provider ID matches the provider ID of the information provider bearing the cost of the memory card. Consequently, the memory card receives only the commodity information issued by that information provider.

Here, the judging unit may prestore a public key of the specific information provider. The information distribution device may prestore a secret key of the specific information provider. The first receiving unit may generate a random number and transmit the generated random number to the information distribution device via the communication terminal. The information distribution device may receive the random number, generate digital signature data from the random number using the secret key, and transmit the generated digital signature data to the memory card via the communication terminal. The judging unit may verify, on the first receiving unit receiving the digital signature data, validity of the digital signature data using the public key to judge whether the commodity information to be received was issued from the specific information provider. The second receiving unit may receive the commodity information if the verification is successful.

With this structure, the memory card judges whether the information distribution device distributes commodity information that is issued by the information provider bearing the cost of the memory card. Consequently, the memory card receives only the commodity information issued by that information provider.

Here, an information provider device may store the commodity information issued from the specific information provider, a second public key of the information distribution device, and a first secret key of the information provider device, apply a digital signature algorithm to the second public key using the first secret key to generate digital signature data, and transmit the generated digital signature data and the second public key to the information distribution device. The information distribution device may prestore a second secret key of the information distribution device, receive the digital signature data and the second public key, and transmit the received digital signature data and second public key to the memory card via the communication terminal. The judging unit may prestore a first public key of the information provider device, receive the digital signature data and the second public key, and verify validity of the digital signature data using the first public key, the digital signature data, and the second public key. The second receiving unit may receive the commodity information if the verification is successful.

With this structure, the memory card judges whether the commodity information to be received is issued by the information provider bearing the cost of the memory card prior to the actual reception. Consequently, the memory card receives only the commodity information issued by that information provider.

Here, the first receiving unit may generate a random number and transmit the generated random number to the information distribution device via the communication terminal. The information distribution device may prestore a common key, receives the random number, encrypt the random number using the common key to generate ciphertext, and transmit the generated ciphertext to the memory card via the communication terminal. The judging unit may prestore a common key that is identical to the common key stored in the information distribution device, and, on the first receiving unit receiving the ciphertext, verify using the common key, whether the received ciphertext is generated from the random number using the common key. The second receiving unit may receive the commodity information if the ciphertext is judged to be valid.

With this structure, the memory card judges whether the information distribution device distributes commodity information that is issued by the information provider bearing the cost of the memory card. Consequently, the memory card receives only the commodity information issued by that information provider.

In yet another aspect, the present invention provides a memory card for storing information transmitted from an information provider to a user. The memory card is portable and mounted on a communication terminal. The memory card is provided to the user on a lease in return for regular payments of a lease fee to the information provider, and includes: a storage unit having a storage area for commodity information issued from the information provider, and a storage area for an electronic ticket having a monetary value; a first transmitting-receiving unit operable to receive a first provider ID identifying the information provider from the information distribution device via the communication terminal; a first writing unit operable to write the received first provider ID to the commodity information storage area; a second transmitting-receiving unit operable to securely transmit, on a regular basis, an electronic ticket having a monetary value equivalent to the lease fee to the information distribution device via the communication terminal; a third transmitting-receiving unit operable to receive from the information distribution device, commodity information that includes a second provider ID identifying an information provider of the commodity information; a judging unit operable to judge whether the second provider ID matches the first provider ID; a second writing unit operable to write, if the first and second provider IDs match, the received commodity information to the commodity information storage area for a purpose of displaying to the user; a fourth transmitting-receiving unit operable to reduce the lease fee by a predetermined amount when the commodity information is written, and securely transmit to the information distribution device via the communication terminal, an electronic ticket having a monetary value equivalent to the post-reduction lease fee; and a third writing unit operable to deducts the transmitted monetary value from the electronic ticket stored in the storage unit.

With this structure, the user can register a provider ID after acquiring the memory card so as to determine an information provider that will bear the cost of the memory card. The memory card then regularly transmits an electronic ticket to the information distribution device, so that the user can lease the memory card. Further, a discount is made on the lease fee in exchange for the memory card writing the commodity information.

In yet another aspect, the present invention provides a memory card for storing information distributed from an information provider to a user. The memory card is portable and mounted on a communication terminal, and includes: a storage unit having a storage area for commodity information issued from the information provider, and a storage area for an electronic ticket having a monetary value; a first transmitting-receiving unit operable to receive a first provider ID identifying the information provider from the information distribution device via the communication terminal; a first writing unit operable to write the received first provider ID to the commodity information storage area; a second transmitting-receiving unit operable to receive from the information distribution device via the communication terminal, commodity information that includes a second provider ID identifying information provider that issued commodity information to be received; a judging unit operable to judge whether the second provider ID matches the first provider ID; a second writing unit operable, if the first and second provider IDs match, to receive the commodity information and write the received commodity information to the commodity information storage area for a purpose of displaying to the user; a third transmitting-receiving unit operable to transmit to the information distribution device via the communication terminal, write-indicate information indicating that the commodity information has been written, and securely receive an electronic ticket generated by the information distribution device for a monetary value based on the write-indicate information; and a third writing unit operable to write the received electronic ticket to the storage unit.

With this structure, the user can register a provider ID after acquiring the memory card so as to determine an information provider that will bear the cost of the memory card. Further, the memory card receives an electronic ticket having a monetary value determined according to the write-indicate information.

In yet another aspect, the present invention provides an information distribution device for distributing information issued from an information provider to a user. The information distribution device includes a transmitting unit operable to transmit, via a communication terminal, commodity information issued from the information provider to a memory card that is provided to the user.

With this structure, the information distribution device distributes to the memory card, the commodity information issued by the specific information provider bearing at least part of the cost of the memory card. Consequently, the memory card is provided to the user at no or lower cost than would otherwise be fully payable by the user.

Here, the information distribution device may generate, when receiving write-indicate information from the memory card, an electronic ticket having a monetary value based on the received write-indicate information. The write-indicate information indicates that the memory card has written the commodity information. The transmitting unit may securely transmit the electronic ticket to the memory card via the communication terminal.

With this structure, the monetary value of the electronic ticket is determined according to the write-indicate information, which encourages the user to receive commodity information.

Here, the transmitting unit may transmit the commodity information that includes coupon information showing a discount to be made on a commodity of the information provider.

With this structure, the information distribution device transmits to the memory card, coupon information showing that a discount is to be made on the commodity, so that adverting effect is achieved.

Here, the information distribution device may receive discount-indicate information from a payment settlement device and generate an electronic ticket for a monetary value based on the received discount-indicate information. The discount-indicate information indicates that the payment settlement device has made the discount shown by the coupon information. The transmitting unit may securely transmit the electronic ticket to the memory card via the communication terminal.

With this structure, the information distribution device transmits an electronic ticket having a monetary value determined according to the discount-indicate information. Consequently, the payment settlement device receives the electronic ticket as a commission for making discounts according to coupon information.

In another aspect, the present invention provides a payment settlement device for settling a payment on a commodity. The payment settlement device includes: a storage unit operable to prestore a first provider ID that identifies an information provider that issues coupon information showing a discount to be made on the commodity; a receiving unit operable to receive via a communication terminal from a memory card used by the user, coupon information including a second provider ID that identifies an information provider that issued the received coupon information; a judging unit operable to judge whether the second provider ID matches the first provider ID; and a discount unit operable to make a discount shown by the received coupon information if the first and second provider IDs match.

With this structure, the payment settlement device gives the user a discount shown by the coupon information received from the memory card. Consequently, the user is encouraged to purchase the commodity.

Here, the coupon information may be transmitted from an information distribution device to the memory card via the communication terminal. The discount unit regularly may transmit discount-indicate information to the information distribution device. The discount-indicate information indicates that the discount shown by the coupon information has been made. The receiving unit may securely receive an electronic ticket that is generated by the information distribution device for a monetary value based on the discount-indicate information. The storage unit may store the received electronic ticket.

With this structure, in response to the discount-indicate information transmitted, the payment settlement device receives from the information distribution device, an electronic ticket as a commission for the discount made.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An information distribution system for distributing information from an information provider to a user, comprising:
an information distribution device for distributing commodity information that serves as an advertisement for a commodity;
a communication terminal for receiving the commodity information, and outputting the received commodity information to a memory card; and
the memory card that is portable and mounted on the communication terminal, wherein
the memory card is provided to the user at a cost borne at least partly by the information provider, and includes:
a storage unit having a storage area for commodity information;
a judging unit operable to judge whether the received commodity information was issued from the information provider; and
a writing unit operable, if the judgment is affirmative, to write the received commodity information to the commodity information storage area for a purpose of displaying to the user.

2. The information distribution system according to claim 1, wherein
the memory card outputs the received commodity information to the communication terminal if the judgment is affirmative, and
the communication terminal receives the commodity information from the memory card and displays the received commodity information.

3. The information distribution system according to claim 2, wherein
the writing unit outputs write-indicate information to the communication terminal if the judgment is affirmative, the write-indicate information indicating that the commodity information has been written,
the communication terminal transmits the received write-indicate information to the information distribution device,
the information distribution device receives the write-indicate information, generates an electronic ticket having a monetary value based on the received write-indicate information, and securely transmits the generated electronic ticket to the memory card via the communication terminal, and
the writing unit writes the received electronic ticket to the storage unit.

4. The information distribution system according to claim 2, wherein
the information distribution device transmits the commodity information that includes coupon information showing a discount to be made on the commodity,
the writing unit writes the commodity information that includes the coupon information, and
the memory card transmits, when the user purchases the commodity, the coupon information via the communication terminal,
the information distribution system further comprising a payment settlement device for receiving the coupon information from the memory card via the communication terminal and making a discount on the commodity based on the received coupon information.

5. The information distribution system according to claim 2, wherein
the memory card is provided to the user on a lease in return for regular payments of a lease fee to the information provider,
the storage unit stores an electronic ticket having a monetary value, and
the memory card securely transmits, on a regular basis, an electronic ticket having a monetary value equivalent to the lease fee to the information distribution device via the communication terminal, and deducts the transmitted monetary value from the electronic ticket stored in the storage unit.

6. The information distribution system according to claim 5, wherein
the memory card reduces the lease fee on outputting the commodity information to the communication terminal for a purpose of displaying to the user, securely outputs an electronic ticket having a monetary value equivalent to the post-reduction lease fee to the communication terminal, and deducts the outputted monetary value from the electronic ticket stored in the storage unit.

7. A memory card provided to a user for storing information transmitted from an information provider to the user, the memory card being portable and mounted on a communication terminal, comprising:
a storage unit having a storage area for commodity information issued from a specific information provider;
a receiving unit operable to receive commodity information from an information distribution device via the communication terminal;
a judging unit operable to judge whether the received commodity information was issued from the specific information provider; and
a writing unit operable, if the judgment is affirmative, to write the received commodity information to the commodity information storage area for a purpose of displaying to the user.

8. The memory card according to claim 7, wherein
the memory card outputs the received commodity information to the communication terminal if the judgment is affirmative, and
the communication terminal receives the commodity information from the memory card and displays the received commodity information.

9. The memory card according to claim 8, wherein
the commodity information includes a first provider ID identifying an information provider that issued the commodity information,
the receiving unit receives the commodity information that includes the first provider ID,
the judging unit prestores a second provider ID identifying the specific information provider, extracts the first provider ID from the received commodity information, and judges whether the received commodity information was issued from the specific information provider, by matching the first provider ID against the second provider ID, and
the writing unit writes the received commodity information to the commodity information storage area if the first and second provider IDs match.

10. The memory card according to claim 8, wherein
the judging unit prestores a public key of the specific information provider,
the information distribution device prestores a secret key of the specific information provider, generates digital signature data from the commodity information using the secret key, and transmits the generated digital signature data,
the judging unit receives the digital signature data via the communication terminal, and verifies validity of the digital signature data using the public key to judge whether the commodity information was issued from the specific information provider, and
the writing unit writes the received commodity information to the commodity information storage area if the verification is successful.

11. The memory card according to claim 8, wherein
the writing unit transmits write-indicate information to the information distribution device via the communication terminal if the commodity information is judged to be issued from the specific information provider, the write-indicate information indicating that the commodity information has been written,. and
the receiving unit securely receives, via the communication terminal, an electronic ticket generated by the information distribution device, the electronic ticket having a monetary value based on the write-indicate information.

12. The memory card according to claim 8, wherein
the memory card is provided to the user on a lease in return for regular payments of a lease fee to the specific information provider,
the storage unit stores an electronic ticket having a monetary value, and
the receiving unit securely transmits, on a regular basis, an electronic ticket having a monetary value equivalent to the lease fee to the information distribution device via the communication terminal, and deducts the transmitted monetary value from the electronic ticket stored in the storage unit.

13. The memory card according to claim 8, wherein
the receiving unit receives the commodity information that includes a priority rank assigned thereto,
the commodity information storage area stores commodity information that includes a priority rank assigned thereto,
the writing unit writes, when enough free space is not left in the commodity information storage area, the received commodity information by overwriting previously stored commodity information that is lowest in priority rank.

14. The memory card according to claim 8, wherein
the commodity information storage area stores commodity information in association with a receiving time of the commodity information,
the writing unit writes, when enough free space is not left in the commodity information storage area, the received commodity information by overwriting previously stored commodity information having an earliest receiving time.

15. The memory card according to claim 8, wherein
the receiving unit further receives another piece of commodity information issued from another information provider,
each piece of commodity information includes a priority rank assigned to a corresponding information provider, and
the writing unit writes, when enough free space is not left in the commodity information storage area, the other piece of commodity information by overwriting previously stored commodity information issued from an information provider having a lower priority rank.

16. The memory card according to claim 8, wherein
the commodity information storage area stores commodity information issued from the specific information provider that bears a cost of the memory card at least partly.

17. A memory card provided to a user for storing information transmitted from an information provider to the user, the memory card being portable and mounted on a communication terminal, comprising:
a storage unit having a storage area for commodity information issued from a specific information provider;
a first receiving unit operable to receive provider information from an information distribution device via the communication terminal, the provider information showing an information provider that issued commodity information to be received;
a judging unit operable to judge based on the received provider information, whether the commodity information was issued from the specific information provider;
a second receiving unit operable to receive the commodity information from the information distribution device via the communication terminal if the judgment is affirmative; and
a writing unit operable to write the received commodity information to the commodity information storage area.

18. The memory card according to claim 17, wherein
the memory card outputs, if the judgment is affirmative and thus receives the commodity information, the received commodity information to the communication terminal, and
the communication terminal receives and displays the commodity information.

19. The memory card according to claim 18, wherein
the commodity information is associated with a first provider ID identifying an information provider that issued the commodity information,
the first receiving unit receives the first provider ID as the provider information,
the judging unit judges whether the received first provider ID matches a second provider ID that identifies the specific information provider, and
the second receiving unit receives the commodity information if the first and second provider IDs match.

20. The memory card according to claim 18, wherein
the judging unit prestores a public key of the specific information provider,
the information distribution device prestores a secret key of the specific information provider,
the first receiving unit generates a random number, and transmits the generated random number to the information distribution device via the communication terminal,
the information distribution device receives the random number, generates digital signature data from the random number using the secret key, and transmits the generated digital signature data to the memory card via the communication terminal,
the judging unit verifies, on the first receiving unit receiving the digital signature data, validity of the digital signature data using the public key to judge whether the commodity information to be received was issued from the specific information provider, and
the second receiving unit receives the commodity information if the verification is successful.

21. The memory card according to claim 18, wherein
an information provider device stores the commodity information issued from the specific information provider, a second public key of the information distribution device, and a first secret key of the information provider device, applies a digital signature algorithm to the second public key using the first secret key to generate digital signature data, and transmits the generated digital signature data and the second public key to the information distribution device,
the information distribution device prestores a second secret key of the information distribution device, receives the digital signature data and the second public key, and transmits the received digital signature data and second public key to the memory card via the communication terminal,
the judging unit prestores a first public key of the information provider device, receives the digital signature data and the second public key, and verifies validity of the digital signature data using the first public key, the digital signature data, and the second public key, and
the second receiving unit receives the commodity information if the verification is successful.

22. The memory card according to claim 18, wherein
the first receiving unit generates a random number and transmits the generated random number to the information distribution device via the communication terminal,
the information distribution device prestores a common key, receives the random number, encrypts the random number using the common key to generate ciphertext, and transmits the generated ciphertext to the memory card via the communication terminal,
the judging unit prestores a common key that is identical to the common key stored in the information distribution device, and, on the first receiving unit receiving the ciphertext, verifies using the common key, whether the received ciphertext is generated from the random number using the common key, and
the second receiving unit receives the commodity information if the ciphertext is judged to be valid.

23. The memory card according to claim 18, wherein
the commodity information storage area stores commodity information issued from the specific information provider that bears a cost of the memory card at least partly.

24. A memory card for storing information transmitted from an information provider to a user, the memory card being portable and mounted on a communication terminal, wherein
the memory card is provided to the user on a lease in return for regular payments of a lease fee to the information provider,
the memory card comprising:
a storage unit having a storage area for commodity information issued from the information provider, and a storage area for an electronic ticket having a monetary value;
a first transmitting-receiving unit operable to receive a first provider ID identifying the information provider from the information distribution device via the communication terminal;
a first writing unit operable to write the received first provider ID to the commodity information storage area;
a second transmitting-receiving unit operable to securely transmit, on a regular basis, an electronic ticket having a monetary value equivalent to the lease fee to the information distribution device via the communication terminal;
a third transmitting-receiving unit operable to receive from the information distribution device., commodity information that includes a second provider ID identifying an information provider of the commodity information;
a judging unit operable to judge whether the second provider ID matches the first provider ID;
a second writing unit operable to write, if the first and second provider IDs match, the received commodity information to the commodity information storage area for a purpose of displaying to the user;
a fourth transmitting-receiving unit operable to reduce the lease fee by a predetermined amount when the commodity information is written, and securely transmit to the information distribution device via the communication terminal, an electronic ticket having a monetary value equivalent to the post-reduction lease fee; and
a third writing unit operable to deducts the transmitted monetary value from the electronic ticket stored in the storage unit.

25. A memory card for storing information distributed from an information provider to a user, the memory card being portable and mounted on a communication terminal, comprising:
a storage unit having a storage area for commodity information issued from the information provider, and a storage area for an electronic ticket having a monetary value;
a first transmitting-receiving unit operable to receive a first provider ID identifying the information provider from the information distribution device via the communication terminal;
a first writing unit operable to write the received first provider ID to the commodity information storage area;
a second transmitting-receiving unit operable to receive from the information distribution device via the communication terminal, commodity information that includes a second provider ID identifying information provider that issued commodity information to be received;
a judging unit operable to judge whether the second provider ID matches the first provider ID;
a second writing unit operable, if the first and second provider IDs match, to receive the commodity information and write the received commodity information to the commodity information storage area for a purpose of displaying to the user;
a third transmitting-receiving unit operable to transmit to the information distribution device via the communication terminal, write-indicate information indicating that the commodity information has been written, and securely receive an electronic ticket generated by the information distribution device for a monetary value based on the write-indicate information; and
a third writing unit operable to write the received electronic ticket to the storage unit.

26. An information distribution device for distributing information issued from an information provider to a user, comprising:
a transmitting unit operable to transmit, via a communication terminal, commodity information issued from the information provider to a memory card that is provided to the user.

27. The information distribution device according to claim 26, wherein
the information distribution device generates, when receiving write-indicate information from the memory card, an electronic ticket having a monetary value based on the received write-indicate information, the write-indicate information indicating that the memory card has written the commodity information, and
the transmitting unit securely transmits the electronic ticket to the memory card via the communication terminal.

28. The information distribution device according to claim 26, wherein the transmitting unit transmits the commodity information that includes coupon information showing a discount to be made on a commodity of the information provider.

29. The information distribution device according to claim 28, wherein
the information distribution device receives discount-indicate information from a payment settlement device and generates an electronic ticket for a monetary value based on the received discount-indicate information, the discount-indicate information indicating that the payment settlement device has made the discount shown by the coupon information, and
the transmitting unit securely transmits the electronic ticket to the memory card via the communication terminal.

30. A payment settlement device for settling a payment on a commodity, comprising:
a storage unit operable to prestore a first provider ID that identifies an information provider that issues coupon information showing a discount to be made on the commodity;
a receiving unit operable to receive via a communication terminal from a memory card used by the user, coupon information including a second provider ID that identifies an information provider that issued the received coupon information;
a judging unit operable to judge whether the second provider ID matches the first provider ID; and
a discount unit operable to make a discount shown by the received coupon information if the first and second provider IDs match.

31. The payment settlement device according to claim 30, wherein
the coupon information is transmitted from an information distribution device to the memory card via the communication terminal,
the discount unit regularly transmits discount-indicate information to the information distribution device, the discount-indicate information indicating that the discount shown by the coupon information has been made,
the receiving unit securely receives an electronic ticket that is generated by the information distribution device for a monetary value based on the discount-indicate information, and
the storage unit stores the received electronic ticket.

32. A program used by a memory card for storing information distributed from an information provider,
wherein the memory card is portable and mounted on a communication terminal, and is provided to the user, and
the memory card includes a storage unit having a storage area for commodity information issued from a specific information provider, the program comprising:
a receiving step of receiving commodity information from an information distribution device via the communication terminal;
a judging step of judging whether the received commodity information was issued from the specific information provider; and
a writing step of writing, if the judgment is affirmative, the received commodity information to the commodity information storage area for a purpose of displaying to the user.

33. A method used by a memory card for storing information distributed from an information provider,
wherein the memory card is portable and mounted on a communication terminal, and is provided to the user, and
the memory card includes a storage unit having a storage area for commodity information issued from a specific information provider, the method comprising:
a receiving step of receiving commodity information from an information distribution device via the communication terminal;
a judging step of judging whether the received commodity information was issued from the specific information provider; and
a writing step of writing, if the judgment is affirmative, the received commodity information to the commodity information storage area for a purpose of displaying to the user.

34. A computer readable recording medium storing a program used by a memory card for storing information distributed from an information provider,
wherein the memory card is portable and mounted on a communication terminal, and is provided to the user, and
the memory card includes a storage unit having a storage area for commodity information issued from a specific information provider, the program comprising:
a receiving step of receiving commodity information from an information distribution device via the communication terminal;
a judging step of judging whether the received commodity information was issued from the specific information provider; and
a writing step of writing, if the judgment is affirmative, the received commodity information to the commodity information storage area for a purpose of displaying to the user.

35. A program for a memory card used by a memory card for storing information distributed from an information provider,
wherein the memory card is portable and mounted on a communication terminal, and is provided to the user, and
the memory card includes a storage unit having a storage area for storing commodity information issued from a specific information provider, the program comprising:
a first receiving step of receiving provider information from an information distribution device via the communication terminal, the provider information showing an information provider that issued commodity information to be received;
a judging step of judging, based on the received provider information, whether the commodity information was issued from the specific information provider;
a second receiving step of receiving the commodity information from the information distribution device via the communication terminal if the judgment is affirmative; and
a writing step of writing the received commodity information to the commodity information storage area.

36. A method for a memory card used by a memory card for storing information distributed from an information provider,
wherein the memory card is portable and mounted on a communication terminal, and is provided to the user, and
the memory card includes a storage unit having a storage area for storing commodity information issued from a specific information provider, the method comprising:
a first receiving step of receiving provider information from an information distribution device via the communication terminal, the provider information showing an information provider that issued commodity information to be received;
a judging step of judging, based on the received provider information, whether the commodity information was issued from the specific information provider;
a second receiving step of receiving the commodity information from the information distribution device via the communication terminal if the judgment is affirmative; and
a writing step of writing the received commodity information to the commodity information storage area.

37. A computer readable recording medium storing a program used by a memory card for storing information distributed from an information provider,
wherein the memory card is portable and mounted on a communication terminal, and is provided to the user, and
the memory card includes a storage unit having a storage area for storing commodity information issued from a specific information provider, the program comprising:
a first receiving step of receiving provider information from an information distribution device via the communication terminal, the provider information showing an information provider that issued commodity information to be received;
a judging step of judging, based on the received provider information, whether the commodity information was issued from the specific information provider;
a second receiving step of receiving the commodity information from the information distribution device via the communication terminal if the judgment is affirmative; and
a writing step of writing the received commodity information to the commodity information storage area.
